(19) United States
(12) Patent Application Publication
(10) Pub. No.: US 2025/0386231 A1
(43) Pub. Date: Dec. 18, 2025

(54) L1-RSRP CALCULATION SCHEME REPORT FOR BASE STATION-BASED BEAM PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US); Tao LUO, San Diego, CA (US)

(21) Appl. No.: 18/881,228

(22) PCT Filed: Aug. 11, 2022
(86) PCT No.: PCT/CN2022/111752

§ 371 Date: Jan. 3, 2025

(51) Int. Cl. H04W 24/10; H04B 17/318; H04L 41/16

(52) U.S. Cl. CPC H04W 24/10; H04B 17/328; H04L 41/16

(57) ABSTRACT

Aspects are provided which allow a UE to provide detailed reporting to a base station regarding the UE's measurement behaviors or calculation schemes that the UE applied to determine its signal quality measurements (e.g., L1-RSRPs or L1-SINRs). For instance, the UE may transmit a message indicating a measurement behavior of the UE. After the UE receives a reference signal associated with a CMR, the UE transmits a report indicating a L1 signal quality metric associated with the CMR. The L1 signal quality metric is based on the measurement behavior indicated in the message. As a result, the base station may have a more reliable collection of data to apply to an AI/ML model for base station-based beam prediction, improving beam management performance or other AI/ML-based beam management.

### TECHNICAL FIELD

The present disclosure generally relates to communication systems, and more particularly, to a wireless communication system between a user equipment (UE) and a base station.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a non-transitory, computer-readable medium, and an apparatus are provided. The apparatus includes a processor; memory coupled with the processor; and instructions stored in the memory and operable, when executed by the processor, to cause the apparatus to: transmit a message indicating a measurement behavior of the apparatus; receive a reference signal associated with a channel measurement resource (CMR); and transmit a report indicating a layer 1 (L1) signal quality metric associated with the CMR, the L1 signal quality metric being based on the measurement behavior.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an example of beam management operations typically associated with 5G (NR) networks.

FIG. 5 illustrates an example of time-domain based beam prediction at a base station or a UE using a ML model.

FIG. 6 illustrates an example of a L1 reference signal receive power (L1-RSRP) calculation scheme in which a UE measures instantaneous L1-RSRP of a synchronization signal block (SSB) in an SSB burst set or a channel state information reference signal (CSI-RS) in a CSI-RS resource set.

FIG. 7 illustrates an example of an L1-RSRPcalculation scheme in which a UE measures and filters multiple, instantaneous L1-RSRPs of SSBs in different SSB burst sets or CSI-RSs in different CSI-RS resource sets.

FIG. 8 illustrates an example where the UE reports an instantaneous time instance associated with a measured L1-RSRP.

FIG. 9 illustrates an example where the UE reports a filtering scheme associated with an obtained L1-RSRP/L1-SINR.

FIG. 10 illustrates an example of a call flow between a UE and a base station.

FIG. 11 illustrates an example of a UCI including adaptively changed behaviors from a previous radio resource control (RRC) message or medium access control (MAC) control element (MAC-CE).

FIG. 12 is a flowchart of a method of wireless communication at a UE.

FIG. 13 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

5G NR (New Radio) supports very high data rates with lower latency in sub-6 GHZ and mmW frequency bands compared to LTE (4G) technology. Due to the propagation loss and other losses associated with the very high frequencies of mmW bands, directional communication is generally applied at such frequencies using antenna arrays with large numbers of antenna elements. As these directional links require accurate alignment of transmitted and received beams, beam pair alignment and other beam management operations have been introduced in 5G NR. Such beam management operations may include, for example, beam sweeping (e.g., covering a spatial area with a set of beams according to pre-specified intervals and directions), beam measurement (e.g., evaluation of the quality of a received signal based on metrics such as reference signal receive power (RSRP) or signal to interference and noise ratio (SINR)), beam determination (e.g., selection of one or more suitable or best beams according to the beam measurements), and beam reporting (e.g., reporting beam quality and beam decision information to the base station). Beam management may thus allow UEs that are not in connection with a base station (e.g., in an idle mode or during initial access), and UEs that are in connection with the base station (e.g., in a connected mode, during tracking, or otherwise when the UE is exchanging data with the network), to acquire and maintain a set of transmission and reception beams to be used for uplink and downlink communications, respectively.

UEs and base stations are also moving towards applying artificial intelligence (AI) or machine learning (ML) for beam management in target use cases for improving performance or reducing complexity of beam management operations. One such target use case in beam management is beam prediction in the time and/or spatial domain, where a base station or UE may utilize an AI/ML model to predict suitable or best beams based on previous beam measurements to reduce overhead and latency and improve accuracy in beam determination or selection. This use case may involve training, deploying, monitoring, and updating the AI/ML model to improve inferences or predictions of best beams for downlink or uplink communications.

To assist a base station in applying beam prediction, a UE may provide a channel state information (CSI) report including L1-RSRPs or L1-SINRs of measured synchronization signal blocks (SSBs) or CSI reference signals (CSI-RSs) for the base station to input into an AI/ML model and predict best future beams. However, the predictive power of AI/ML models depends to a large extent on the quality of data on which these models are trained and inferred, and the amount of reliable data collected for training and inferences may be limited in conventional beam management reporting frameworks. For instance, when a UE conventionally reports L1-RSRPs of SSBs to a base station in a CSI report, the UE does not include information regarding if, or when, the UE has filtered its RSRP measurements over multiple SSB bursts, nor information regarding the age of an L1-RSRP measurement in the SSB beam report. As a result, this lack of information may inhibit the base station's ability to curate suitable datasets on which AI/ML models can be trained, verified, tested, and deployed for beam prediction. Therefore, it would be helpful for the UE to report more detailed information regarding its L1-RSRP or L1-SINR calculation schemes or other information associated with its measurements to provide the base station additional data to reliably perform beam prediction.

Accordingly, aspects of the present disclosure describe an enhancement to the L1-RSRP or L1-SINR reporting of the UE in which the UE may provide detailed signaling to the base station regarding the UE's calculation schemes or other information that the UE applied to determine its reported measurements. This detailed information may include, for example, whether the reported L1-RSRPs/L1-SINRs are associated with an instantaneous measurement, the specific time instances associated with the instantaneous measurement, the reception beams associated with the measurement, whether filtering is applied on the reported L1-RSRPs/L1-SINRs, the specific filtering schemes associated with the L1-RSRPs/L1-SINRs, a time window or time instances associated with the filtering schemes, reception beams associated with the different time instances associated with the filtering schemes, through what signaling the L1-RSRP or L1-SINR calculation schemes are reported, for instance, via RRC, MAC-CE, UCI, or application layer protocols, or any combination of the foregoing. As a result, the base station may have a more reliable collection of data to apply to an AI/ML model for base station-based beam prediction, improving beam management performance.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

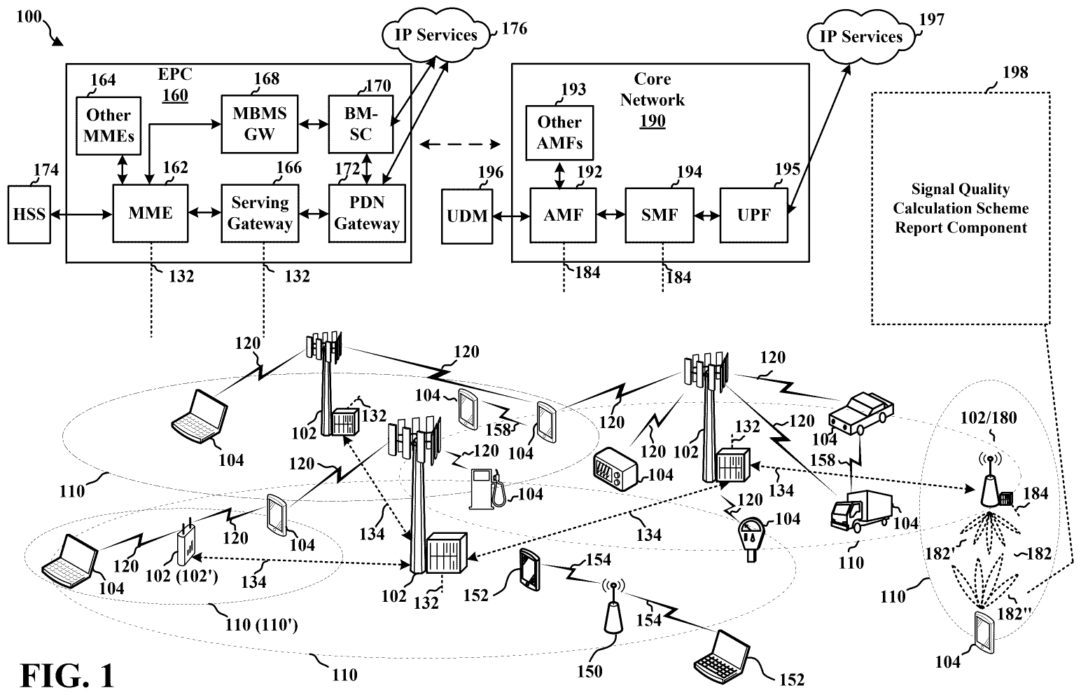

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1, in certain aspects, the UE 104 may include a signal quality calculation scheme report component 198 that is configured to transmit a message indicating a measurement behavior of the UE; receive a reference signal associated with a channel measurement resource (CMR); and transmit a report indicating a layer 1 (L1) signal quality metric associated with the CMR, the L1 signal quality metric being based on the measurement behavior.

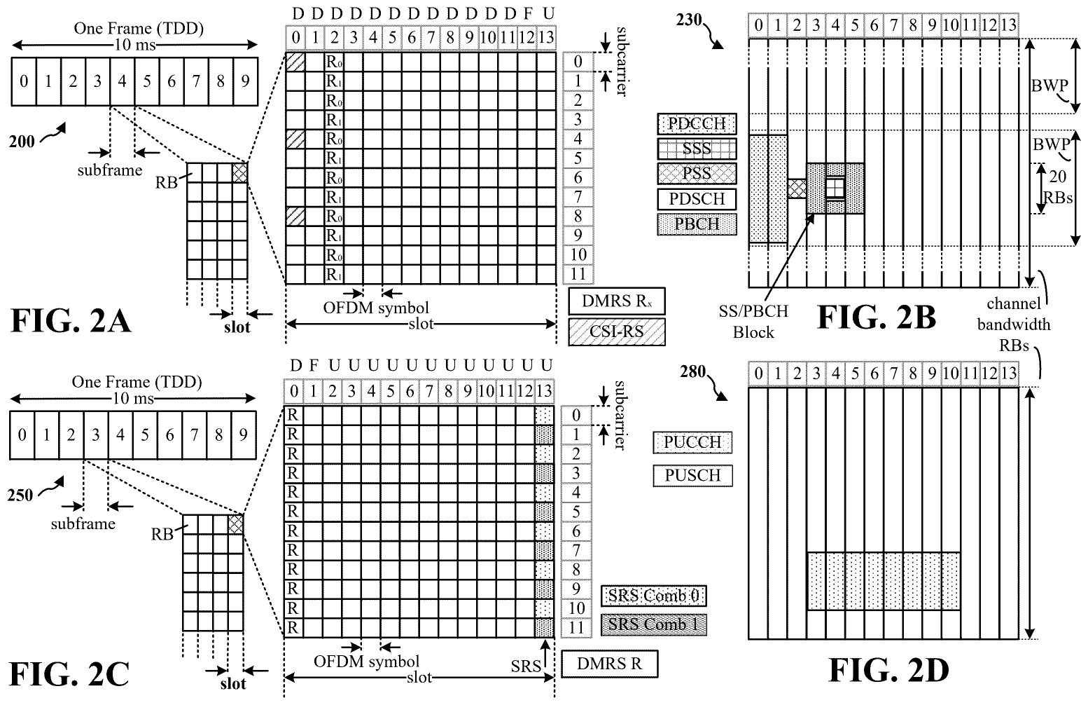

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28,respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}* 15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

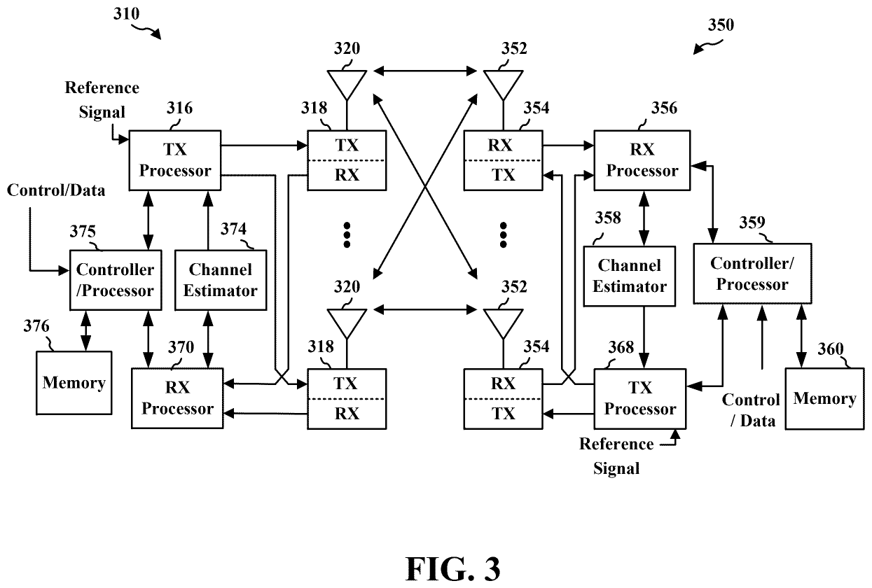

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with signal quality calculation scheme report component 198 of FIG. 1. 5G NR (New Radio) supports very high data rates with lower latency in sub-6 GHZ and mmW frequency bands compared to LTE (4G) technology. Due to the propagation loss and other losses associated with the very high frequencies of mmW bands, directional communication is generally applied at such frequencies using antenna arrays with large numbers of antenna elements. As these directional links require accurate alignment of transmitted and received beams, beam pair alignment and other beam management operations have been introduced in 5G NR. Such beam management operations may include, for example, beam sweeping (e.g., covering a spatial area with a set of beams according to pre-specified intervals and directions), beam measurement (e.g., evaluation of the quality of a received signal based on metrics such as reference signal receive power (RSRP) or signal to interference and noise ratio (SINR)), beam determination (e.g., selection of one or more suitable or best beams according to the beam measurements), and beam reporting (e.g., reporting beam quality and beam decision information to the base station). Beam management may thus allow UEs that are not in connection with a base station (e.g., in an idle mode or during initial access), and UEs that are in connection with the base station (e.g., in a connected mode, during tracking, or otherwise when the UE is exchanging data with the network), to acquire and maintain a set of transmission and reception beams to be used for uplink and downlink communications, respectively.

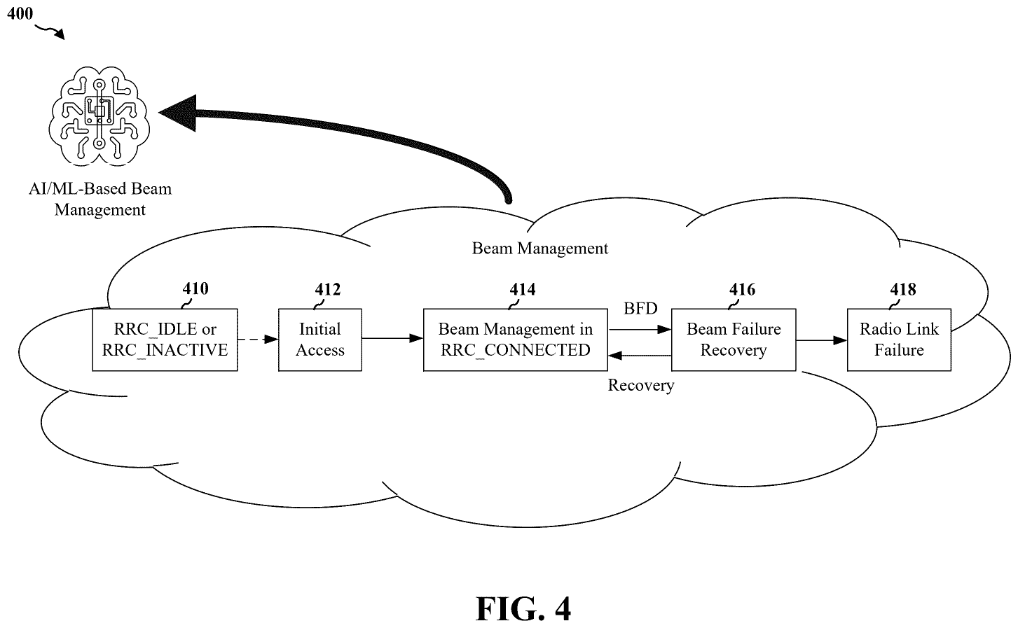

FIG. 4 illustrates an example 400 of beam management operations typically associated with 5G (NR) networks. UEs that are in an RRC_IDLE or RRC_INACTIVE mode 410 may perform beam management using tracking reference signals (TRS) and during initial access 412 using synchronization signal block (SSB) (wide) beam sweeping. SSBs may be associated with random access channel (RACH) occasions (ROs) or RACH preambles with which UEs may perform contention-based random access (CBRA). UEs that are in an RRC_CONNECTED mode 414 may perform various beam management operations, for example, beam selection and refinement using SSBs or CSI-RS (e.g., P1/P2/P3 procedures), beam selection and refinement using SRS (e.g., U1/U2/U3 procedures), layer one (L1)-RSRP reporting, transmission configuration indicator (TCI) state configurations or indications, L1-SINR reporting, and other operations associated with beam management, enhanced beam management (eBM), and further enhanced beam management (FeBM). Connected UEs may also perform beam failure detection (BFD) based on beam measurements, in which case these UEs may perform beam failure recovery (BFR) 416 to remain in RRC_CONNECTED mode. UEs may perform BFD and BFR in primary cells (PCells), primary secondary cells (PSCells), or secondary cells (SCells). Radio link failure 418 is also supported in beam management.

As illustrated in FIG. 4, UEs are also moving towards applying artificial intelligence (AI) or machine learning (ML) for beam management in target use cases for improving performance or reducing complexity of beam management operations. One such target use case in beam management is beam prediction in the time and/or spatial domain, where a base station or UE may utilize an AI/ML model to predict suitable or best beams based on previous beam measurements to reduce overhead and latency and improve accuracy in beam determination or selection. This use case may involve training, deploying, monitoring, and updating the AI/ML model to improve inferences or predictions of best beams for downlink or uplink communications.

AI/ML-based predictive beam management is an attractive alternative to conventional beam management. In conventional beam management, beam qualities or failures are identified via beam measurements. Measuring every beam to determine a best beam or a beam failure may require significant device power or overhead to achieve sufficient performance, limit beam accuracy if restrictions are imposed on the amount of power or overhead that can be used, and impact latency and throughput due to beam resuming efforts. However, in predictive beam management, non-measured beam qualities may be predicted, leading to reduced power and overhead, and future beam blockages or failures may be predicted, leading to improvements in accuracy, latency, or throughput. Moreover, beam prediction itself is a highly non-linear task, and thus AI/ML-based beam prediction may assist in this regard. For example, predicting future transmission beam qualities may depend on a UE's moving speed or trajectory, the reception beams that are or will be used, interference, and other parameters that are difficult to model via conventional statistical signal processing methods.

AI/ML-based beam prediction and training may be performed at a UE or a base station. Generally for predictions, UE performance may outweigh base station performance at the expense of a tradeoff between performance and UE power. For instance, the UE may perform more observations (via measurements) than the base station (via UE feedback) to predict future downlink transmission beam qualities. While this may result in prediction at the UE outperforming prediction at the base station, more UE power is consumed by these inference efforts. For model training, training at the network generally involves effort in data collection while model training at the UE generally involves effort in UE computation. For instance, if model training is conducted at the network, the network may undergo effort in collecting measurement data or other prediction data via the air interface with the UE or via an application-layer approach, while if model training is conducted at the UE, the UE may undertake additional computation or buffering efforts for training and data storage.

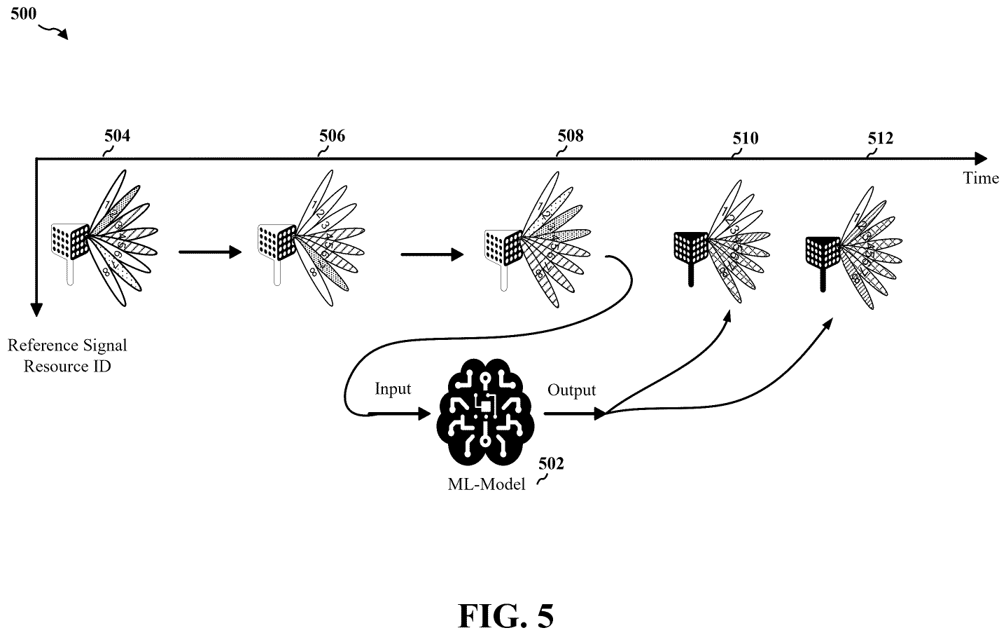

FIG. 5 illustrates an example 500 of time-domain based beam prediction at the base station or the UE using a ML model 502. Initially, as in conventional beam management, the base station may perform a transmission beam sweep of various transmission beams respectively carrying a CSI-RS or an SSB associated with a different resource identifier. For instance, as illustrated in FIG. 5, a first portion of the transmission beams may be swept at time instance 504, a second portion of the transmission beams may be swept at time instance 506, and a third portion of the transmission beams may be swept at time instance 508. The UE may perform L1-RSRP measurements of the CSI-RSs or SSBs at the different time instances, and the UE may report these RSRPs to the base station (e.g., in a CSI report) for input to the ML model 502 at the base station if beam prediction is performed at the base station. Alternatively, if beam prediction is performed at the UE, the UE may input these measured RSRPs into the ML model 502 at the UE.

Wherever beam prediction is applied, the ML model 502 may output one of multiple target results, including for example, predicted RSRPs of future transmission beams directed towards the UE, predicted candidate beams for transmission of downlink data to the UE, or predicted beam failures or blockages. The former two examples may result in reduced UE power or UE-specific reference signal overhead, while the latter example may result in better latency or throughput. Thus, in the illustrated example of FIG. 5, the UE or base station may predict from the ML model 502 the most suitable or best transmission beams based on predicted L1-RSRPs at different time instances 510, 512 from the historical measurements that were input to ML model 502. As a result, ML-based beam management may reduce the communication overhead of the wireless communication system, thereby increasing usable memory capacity in the UE or base station (the device) and extending device battery life.

Thus, in base station-based beam prediction, a UE may report to a base station historical measurements such as L1-RSRP or L1-SINR of transmitted SSBs or CSI-RS for input into an AI/ML-based beam prediction model. To allow such reporting, the base station may provide a CSI report configuration indicating the UE which quantity to report (e.g., via a parameter reportQuantity or another name). This report quantity may be the RSRP of a specific SSB index (e.g., reportQuantity=ssb-Index-RSRP), the SINR of a specific SSB index (e.g., reportQuantity=ssb-Index-SINR), the RSRP of a specific CSI-RS index (e.g., reportQuantity=cri-RSRP), or the SINR of a specific CSI-RS index (e.g., reportQuantity=cri-SINR). Thus, the CSI report configuration may configure joint SSB resource indicator (SSBRI)/CSI-RS resource indicator (CRI) and L1-RSRP/L1-SINR beam reporting. Moreover, the CSI report configuration may indicate the UE to report the aforementioned measurements respectively for an RRC configured number of reported reference signals (in parameter nrofReportedRS or another name), which may typically be up to two or four different SSBRI or CRI depending on UE capability for a given CSI report configuration.

Measurement reporting of L1-RSRP may be based on pre-defined measurement report mapping tables. For example, when the UE reports L1-RSRP for a strongest SSBRI or CRI out of a plurality of SSBRIs or CRIs, the UE may report a RSRP value in the inclusive range of [−140, −44] dBm out of 7 bits of RSRP values or code-points respectively separated by a 1 dBm step size (or resolution) in a pre-defined measurement report mapping table. For the remaining SSBRIs or CRIs, the UE may report a differential RSRP value in the inclusive range of [0, −30] dB out of 4 bits of differential RSRP values or code-points respectively separated by a 2 dB step size (or resolution) relative to the strongest SSBRI or CRI's L1-RSRP in another pre-defined measurement report mapping table. As an example, if the UE measures the strongest CRI of a transmission beam sweep to be −45 dBm and the second strongest CRI of the transmission beam sweep to be −48 dBm, the UE may provide a CSI report indicating RSRP_112 for the strongest beam (which may be associated with −45 dBm) and DIFFRSRP_1 for the second strongest beam (which may be associated with ΔRSRP =−3 relative to the strongest beam, or −48 dBm). The available code-points for reporting an L1-RSRP for the strongest beam may be less than the total amount of code-points available for reporting in the associated measurement report mapping table (i.e., there are invalid code-points). For instance, UE may select one of 97 code-points or individual L1-RSRP values measured for the strongest beam from a mapping table including 128 code-points (or bit values out of 7 bits), where the remaining 31 code-points are invalid for L1-RSRP reporting (e.g., the UE may apply those code-points only for layer three (L3)-RSRP reporting).

Measurement reporting of L1-SINR may similarly be based on pre-defined measurement report mapping tables. For example, when the UE reports L1-SINR for a strongest SSBRI or CRI out of a plurality of SSBRIs or CRIs, the UE may report a SINR value in the inclusive range of [−23, 40] dB out of 7 bits of SINR values or code-points respectively separated by a 0.5 dB step size (or resolution) in another pre-defined measurement report mapping table. For the remaining SSBRIs or CRIs, the UE may report a differential SINR value in the inclusive range of [0, −15] dB out of 4 bits of differential SINR values or code-points respectively separated by a 1 dB step size (or resolution) relative to the strongest SSBRI or CRI's L1-SINR in another pre-defined measurement report mapping table. Here, unlike for L1-RSRP, there may be no invalid code-points for reporting an L1-SINR in its associated measurement report mapping table.

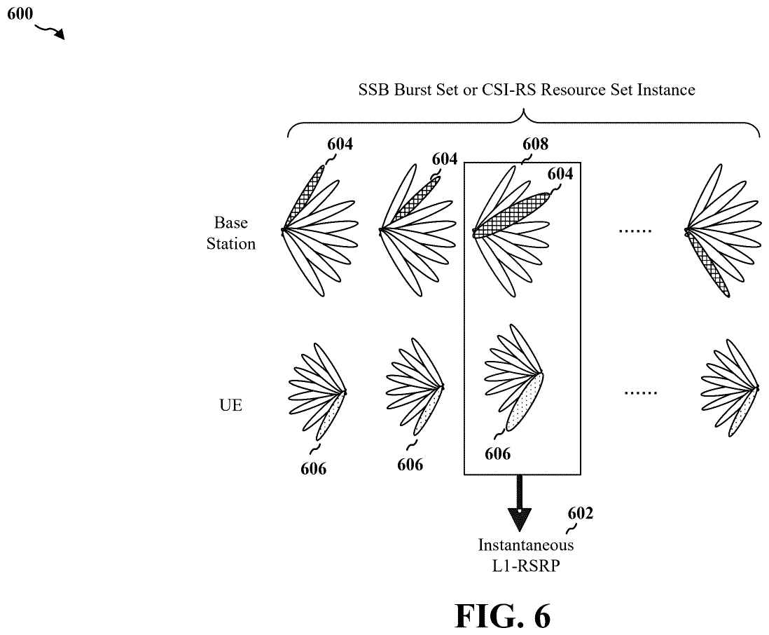

FIG. 6 illustrates an example 600 of an L1-RSRP calculation scheme in which a UE measures instantaneous L1-RSRP 602 of an SSB in an SSB burst set or a CSI-RS in a CSI-RS resource set. While the example of FIG. 6 specifically illustrates L1-RSRP, in other examples, references to L1-RSRP may be replaced by L1-SINR. A base station may perform a beam sweep in which the base station transmits SSBs or CSI-RSs in different transmission beams 604 during respective time instances while the UE maintains a same reception beam 606 for receiving the reference signal during these respective time instances. The UE may measure the L1-RSRP of the reference signal at a time instance 608 during the beam sweep, thus obtaining an instantaneous L1-RSRP measurement. Afterwards, the UE may transmit a report to the base station indicating the 7-bit L1-RSRP value (or 4-bit differential L1-RSRP value) associated with the instantaneous L1-RSRP measurement in the associated measurement report mapping table.

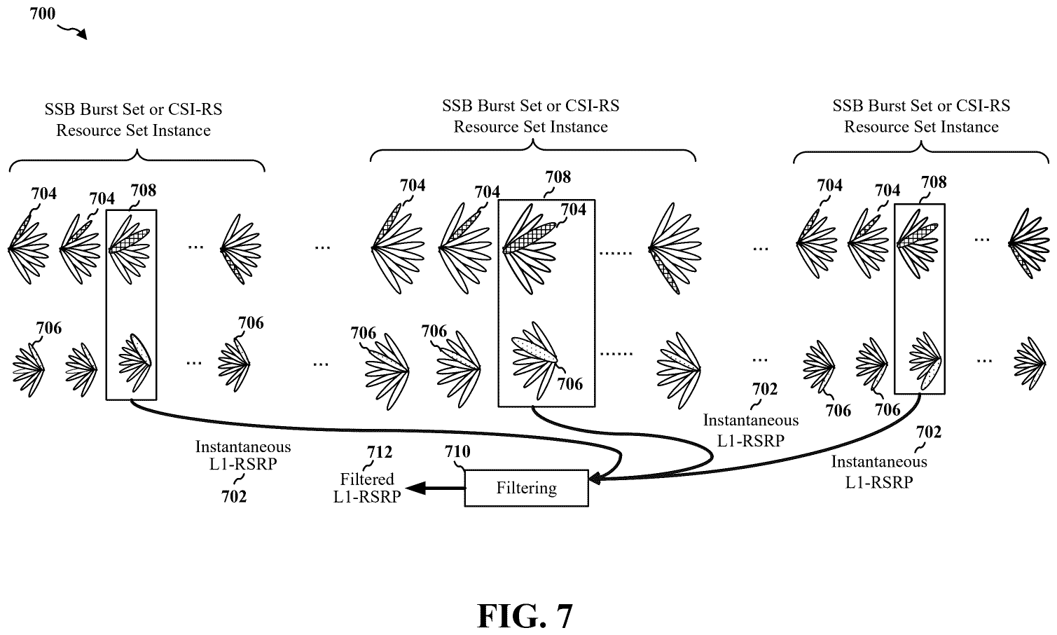

FIG. 7 illustrates an example 700 of an L1-RSRP calculation scheme in which a UE measures and filters multiple, instantaneous L1-RSRPs 702 of SSBs in different SSB burst sets or CSI-RSs in different CSI-RS resource sets. While the example of FIG. 7 specifically illustrates L1-RSRP, in other examples, references to L1-RSRP may be replaced by L1-SINR. A base station may perform multiple beam sweeps, where in a respective beam sweep, the base station transmits SSBs or CSI-RSs in different transmission beams 704 during respective time instances while the UE maintains a same reception beam 706 for receiving the reference signal during these respective time instances 708. As illustrated in FIG. 7, the UE may change its reception beam 706 between different SSB burst sets or different CSI-RS resource sets (that is, between respective beam sweeps). For each SSB burst set or CSI-RS resource set (that is, for a respective beam sweep), the UE measures the L1-RSRP of the reference signal at time instance 708, thereby obtaining multiple instantaneous L1-RSRP measurements at respective time instances 708 across the multiple beam sweeps. The UE then performs filtering 710 on the instantaneous L1-RSRP measurements, for example averaging or weighted averaging, and subsequently obtains a filtered L1-RSRP measurement 712 associated with the multiple L1-RSRP measurements. The UE may then transmit a report to the base station indicating the 7-bit L1-RSRP value (or 4-bit differential L1-RSRP value) associated with the filtered L1-RSRP measurement in the associated measurement report mapping table.

Thus, a UE may report L1-RSRP or L1-SINR of measured SSBs or CSI-RS to a base station for the base station to input into an AI/ML model and predict best future beams. However, the predictive power of AI/ML models depends to a large extent on the quality of data on which these models are trained and inferred, and the amount of reliable data collected for training and inferences may be limited in conventional beam management reporting frameworks. For instance, when a UE conventionally reports L1-RSRPs of SSBs to a base station, the UE does not include information regarding if, or when, the UE has filtered its RSRP measurements over multiple SSB bursts, nor information regarding the age of an L1-RSRP measurement in the SSB beam report (the UE currently only reports that the measurement is performed within a time window or defined measurement period T_{L1-RSRP_Measurement_Period_SSB}. For instance, referring to FIGS. 6 and 7, the UE may not report information regarding the time instances 608, 708 or the filtering 710 associated with the L1-RSRP or L1-SINR measurements; the UE just reports the end result (e.g., the filtered measurement). As a result, this lack of information may inhibit the base station's ability to curate suitable datasets on which AI/ML models can be trained, verified, tested, and deployed for beam prediction. Therefore, it would be helpful for the UE to report more detailed information regarding its L1-RSRP or L1-SINR calculation schemes or other information associated with its measurements to provide the base station additional data to reliably perform beam prediction.

Accordingly, aspects of the present disclosure describe an enhancement to the L1-RSRP or L1-SINR reporting of the UE in which the UE may provide detailed signaling to the base station regarding the UE's calculation schemes or other information that the UE applied to determine its reported measurements. This detailed information may include, for example, whether the reported L1-RSRPs/L1-SINRs are associated with an instantaneous measurement, the specific time instances associated with the instantaneous measurement, the reception beams associated with the measurement, whether filtering is applied on the reported L1-RSRPs/L1-SINRs, the specific filtering schemes associated with the L1-RSRPs/L1-SINRs, a time window or time instances associated with the filtering schemes, reception beams associated with the different time instances associated with the filtering schemes, and through what signaling the L1-RSRP or L1-SINR calculation schemes are reported, for instance, via RRC, MAC-CE, UCI, or application layer protocols. As a result, the base station may have a more reliable collection of data to apply to an AI/ML model for base station-based beam prediction, improving beam management performance.

In one aspect, the base station may configure or indicate the UE not only to report L1-RSRPs/L1-SINRs associated with a number of channel measurement resources (CMRs), such as CSI-RSs or SSBs, but also to report the calculation method associated with the reported L1-RSRPs/L1-SINRs. In one example, the UE may report the calculation method by including details in its report regarding whether the reported L1-RSRPs/L1-SINRs are associated with an instantaneous measurement, and if so, the specific time instance(s) associated with the instantaneous measurement(s). The UE may also optionally report the reception beam(s) associated with the instantaneous measurement(s). In another example, the UE may report the calculation method by including details in its report regarding whether filtering is applied on the reported L1-RSRPs/L1-SINRs, and if so, the filtering schemes associated with the measurements that are used. The UE may also optionally report a time window or a plurality of time instances associated with the filtering schemes (e.g., which samples are considered to obtain the filtered result), and/or the reception beam(s) associated with the different time instances considered for filtering. In a further example, the UE may report such L1-RSRP/L1-SINR calculation schemes (any of the aforementioned details) via an RRC message, a MAC-CE, UCI, or an application layer protocol. If the UE is applying an AI/ML model for its L1-RSRP/L1-SINR calculations (e.g., for filtering), the UE may optionally report the associated AI/ML model information for the base station to consider in its own AI/ML model for beam prediction.

In an additional example, the base station may provide the reported calculation schemes (the aforementioned details) as one or more inputs to an AI/ML model associated with beam management or prediction, and the level of details which the UE determines to report may be based on a balance or tradeoff between the AI/ML model performance and a disclosure level of the UE. For instance, the network may pre-define or the base station may pre-configure the UE to report more details for better AI/ML model performance if the UE has a higher disclosure level (i.e., the UE is unrestricted or less restricted on disclosing its calculation method/details). Conversely, the network may pre-define or the base station may pre-configure the UE to report less details (or to select which details to report), notwithstanding the cost to AI/ML model performance as a result, if the UE has a lower disclosure level (i.e., the UE is more restricted on disclosing its calculation method/details, or if the details are flagged or otherwise associated with confidentiality).

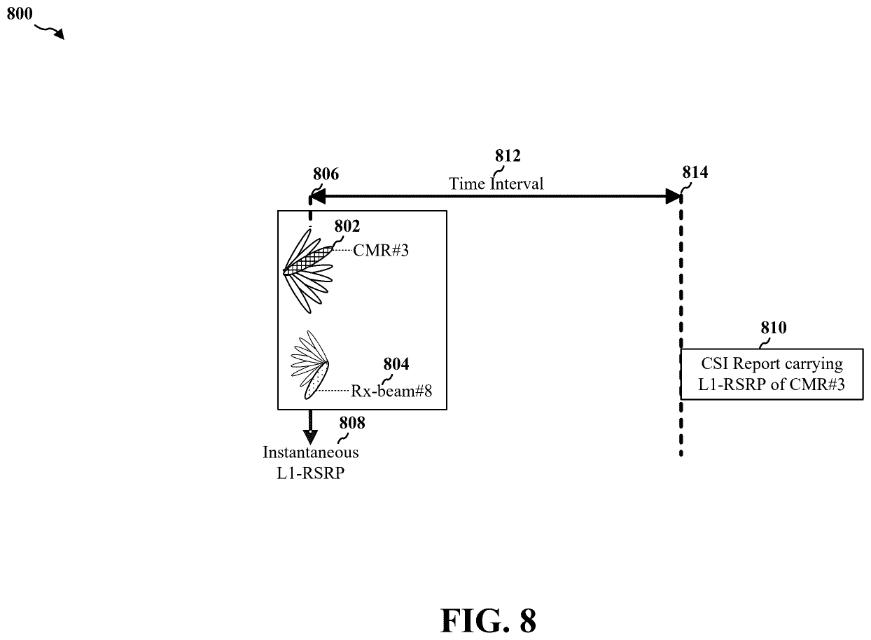

FIG. 8 illustrates an example 800 where the UE reports an instantaneous time instance associated with a measured L1-RSRP. While this example specifically refers to L1-RSRP, it should be understood that it can similarly apply to L1-SINR. For a given L1-RSRP/L1-SINR which the UE intends to report, the UE may further report whether this metric is identified based on an instantaneous measurement of the associated CMR. If the metric is identified based on an instantaneous measurement of the associated CMR, the UE may further report the specific instantaneous time instance in which the measurement was obtained. For example, the UE may report the time interval (in terms of a unit of time, such as milliseconds, subframes, frames, or slots, or in terms of the periodicity for a periodic or semi-persistently scheduled CMR) between the slot carrying the L1-RSRP/L1-SINR (the report) and the slot where the UE measured the L1-RSRP/L1-SINR of the CMR. For instance, in the example 800 of FIG. 8, the UE may receive a plurality of CMRs (e.g., CSI-RS) in different transmission beams 802 from the base station via a same reception beam 804 at the UE. At a time instance 806 during which the UE receives CMR #3 (e.g., a third CSI-RS in a CSI resource set), the UE may perform an instantaneous L1-RSRP measurement 808 of the received CMR, after which the UE may transmit a CSI report 810 carrying the L1-RSRP of this CMR #3. In the CSI report 810, the UE may further include a time interval 812 between a time 814 when the UE transmits the CSI report and the time instance 806 during which the UE obtained the L1-RSRP measurement 808. Thus, the UE may report the specific time instance (via time interval 812) associated with the instantaneous measurement to assist the base station in more reliably performing beam prediction. For instance, the base station may attempt to determine a UE-preferred transmission beam for future downlink transmissions based on the reported instantaneous measurements.

Furthermore, in addition to reporting the time instance in which the L1-RSRP/L1-SINR measurement of a CMR was obtained (e.g., time interval 812), the UE may further report information regarding a reception beam which the UE used to receive the CMR at this time instance. For instance, the UE may report an identifier associated with the reception beam, an identifier of a panel including an antenna associated with the reception beam, or an identifier associated with a polarization of a signal received via the reception beam. These identifiers, in turn, may be further based on a UE pre-reported capability and associated base station configuration for defining such identifiers. Moreover, the UE may report a direction towards which the reception beam points, and/or orientation information of the UE, at the time instance. Thus, in the example 800 of FIG. 8, if the reception beam 804 by which UE receives CMR #3 at time instance 806 is Rx-beam #8, the UE may report any of the aforementioned information associated with Rx-beam #8 in the CSI report 810 to the base station. In this way, the base station may determine at least the direction in which the UE received a specific CMR at a specific instance in time. Furthermore, to better assist the base station in more reliably performing beam prediction, the UE may similarly report multiple instantaneous measurements, multiple time instances during which the measurements were respectively performed, and the associated reception beam(s) at which point the CMRs associated with the measurements were respectively received. Moreover, the UE may report this instantaneous information without performing filtering or reporting filtering information, since this approach effectively moves or offloads the UE's typical filtering efforts to the base station side and thus minimizes reporting overhead.

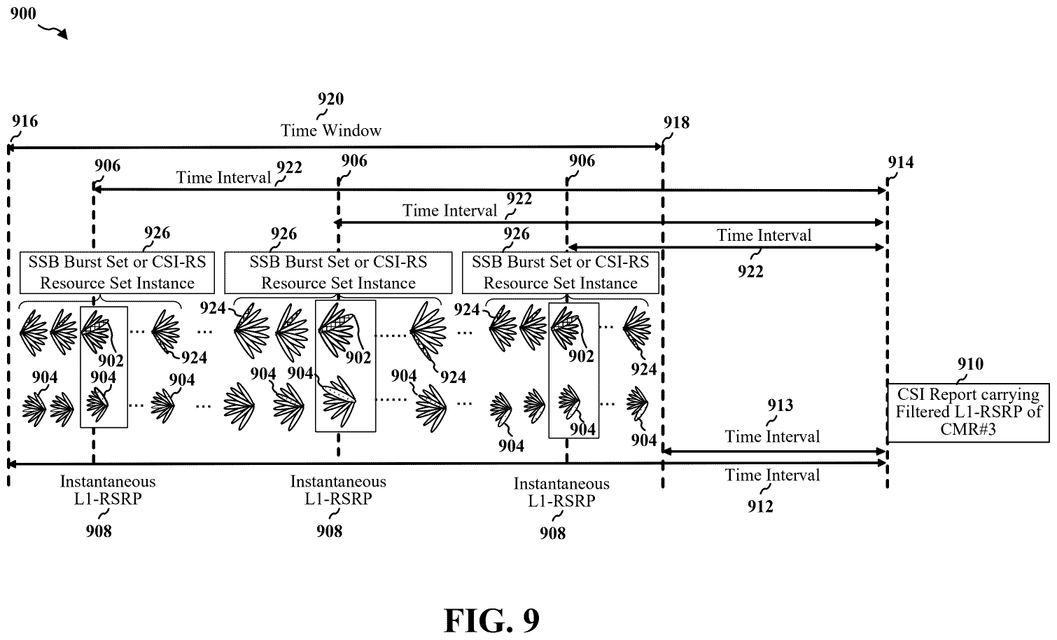

FIG. 9 illustrates an example 900 where the UE reports a filtering scheme associated with an obtained L1-RSRP. While this example specifically refers to L1-RSRP, it should be understood that it can similarly apply to L1-SINR. For a given L1-RSRP/L1-SINR associated with a CMR which the UE intends to report, the UE may further report whether this metric is identified based on temporal filtering, spatial domain filtering, or other filtering scheme. If the metric is identified based on a filtering scheme, the UE may further report information regarding the specific filtering scheme applied. In one example where the filtering scheme is temporal filtering, this filtering information may include the specific time window or the specific time instances where the UE measured and filtered L1-RSRPs/L1-SINRs associated with the CMR. For example, the UE may report the time interval (in terms of a unit of time, such as milliseconds, subframes, frames, or slots, or in terms of the periodicity for a periodic or semi-persistently scheduled CMR) between the slot carrying the L1-RSRP/L1-SINR (the report) and either: the starting point or ending point of the time window, or alternatively the slots associated with the multiple specific time instances, in which the UE measured the L1-RSRPs/L1-SINRs of the CMR.

For instance, in the example 900 of FIG. 9, the UE may receive a CMR (e.g., CSI-RS) in a same transmission beam 902 from the base station via different reception beams 904 at the UE at respective time instances 906. At each of the time instances 906 during which the UE receives the CMR, the UE may perform an L1-RSRP measurement 908 of the received CMR. After obtaining the L1-RSRP measurements 908 of the CMR over the respective time instances 906, the UE may filter the L1-RSRP measurements 908 to obtain a filtered L1-RSRP of the CMR, and the UE may transmit a CSI report 910 carrying the filtered L1-RSRP. In the CSI report 910, the UE may further include a time interval 912, 913 between a time 914 when the UE transmits the CSI report 910 and either a start time 916 (corresponding to time interval 912) or an end time 918 (corresponding to time interval 913) of a time window 920 during which the UE obtained the L1-RSRP measurements 908. Alternatively, in the CSI report 910, the UE may further include respective time intervals 922 between the time 914 when the UE transmits the CSI report 910 and the respective time instances 906 during which the UE obtained the L1-RSRP measurements 908. Thus, the UE may report the specific time window (via time interval 912, 913) or the specific time instances (via respective time intervals 922) associated with the temporally filtered measurement to assist the base station in more reliably performing beam prediction.

Furthermore, in the event the UE reports specific time instances in which the L1-RSRP/LI-SINR measurement of a CMR was obtained (e.g., via respective time intervals 922), the UE may further report information regarding the reception beam(s) which the UE used to receive the CMR at these time instances. For instance, the UE may report an identifier associated with the reception beam(s), an identifier of a panel including an antenna associated with the reception beam(s), or an identifier associated with a polarization of a signal received via the reception beam(s). These identifiers, in turn, may be further based on a UE pre-reported capability and associated base station configuration for defining such identifiers. Moreover, the UE may report a direction towards which the reception beam(s) points, and/or orientation information of the UE, at the time instances. Thus, in the example 900 of FIG. 9 where the UE receives the CMR at respective time instances 906 via different reception beams 904, the UE may further report any of the aforementioned information associated with these different reception beams 904 in the CSI report 910 to the base station.

In another example where the filtering scheme is spatial filtering, this filtering information reported to the base station may include the specific other CMRs which helped the UE in determining the L1-RSRP/L1-SINR for the considered CMR, as well as optionally the measured L1-RSRPs/L1-SINRs themselves and/or the time window or time instances associated with these measurements. For instance, referring to the example 900 of FIG. 9, the UE may receive multiple CMRs in different transmission beams 924 within respective periods of time 926 (e.g., corresponding to respective SSB burst sets or CSI-RS resource set instances). Thus, during one of the respective periods of time 926, the UE may not only obtain L1-RSRP measurement 908 of the CMR carried in transmission beam 902 during the corresponding one of the respective time instances 906, but also instantaneous L1-RSRP measurements of the other CMRs carried in the different transmission beams 924 (neighboring beams) during other time instances within the burst set or resource set instance. The UE may then filter these instantaneous L1-RSRP measurements including those associated with these neighboring beams in the same SSB burst set or CSI-RS resource set to obtain a spatially filtered L1-RSRP, and the UE may include this filtered metric in the CSI report 910. Moreover, to assist the base station in more reliably performing beam prediction., the UE may include in the CSI report 910 the identifiers of the CMRs from which the filtered metric was derived, including the CMR carried in the transmission beam 902 and the other CMRs carried in the different transmission beams 924. Additionally, to further assist the base station, the UE may further include in the CSI report 910 the instantaneous L1-RSRP measurements, and/or the specific time window (via time interval(s) 912, 913) or time instances (via respective time interval(s) 922) associated with these instantaneous L1-RSRP measurements, which the UE used to derive the spatially filtered measurement.

In a further example where the filtering scheme is analytical filtering, this filtering information may include information regarding the specific analytical filtering algorithms the UE applied to perform the filtering, such as averaging or weighted averaging, or the applicable weights used in weighted averaging. For instance, referring to the example 900 of FIG. 9, after obtaining the L1-RSRP measurements 908 of the CMR over the respective time instances 906 (e.g., in temporal filtering) and/or the L1-RSRP measurements of other CMRs in different transmission beams 924 (e.g., in spatial filtering), the UE may filter these L1-RSRP measurements to obtain a filtered L1-RSRP of the CMR(s). To perform this filtering, the UE may apply an analytical method such as averaging the different L1-RSRP measurements, linearly combining or applying weighted averaging to the L1-RSRP measurements, applying nonlinear filtering involving recursive calculations, applying filtering in an AI/ML neural network, or other methods. For example, the UE may apply higher weights to L1-RSRP measurements associated with the same CMR and lower weights to L1-RSRP measurements associated with different CMRs. To assist the base station in more reliably performing beam prediction, the UE may include in the CSI report 910 information regarding the analytical method applied, for example, whether averaging or weighted averaging was used, and if weighted averaging was used, the different weights that were applied. For example, different filtering algorithms or analytical methods may be associated with different bit values (e.g., one bit value for averaging, another bit value for weighted averaging, different bit values for different weights, different bit values for etc.), and the UE may report one or more of these bit values in the CSI report 910 accordingly. Similarly, depending on a disclosure level or conservative level of behavior of the UE, the UE may be selective as to which level of filtering detail is included in the CSI report 910. For example, the UE may choose to include information associated with temporal filtering in the CSI report, but not information associated with spatial filtering, analytical filtering, or AI/ML filtering, albeit at an expense to performance of a beam prediction AI/ML model at the base station.

In an additional example where the filtering scheme is AI/ML-based filtering, the filtering information may include information regarding a specific AI/ML model used for the filtering and the definitions of the inputs to and outputs from the AI/ML model. For instance, referring to the example 900 of FIG. 9, if the UE filters the L1-RSRP measurements 908 of the CMR over the respective time instances 906 (e.g., in temporal filtering) and/or the L1-RSRP measurements of other CMRs in different transmission beams 924 (e.g., in spatial filtering), the UE may input these measurements into an AI/ML model which outputs information associated with the filtered L1-RSRP value. In the CSI report 910, the UE may include the filtered L1-RSRP value, as well as include information regarding the inputs or outputs used for obtaining this filtered L1-RSRP value (e.g., the L1-RSRP measurements or the output information).

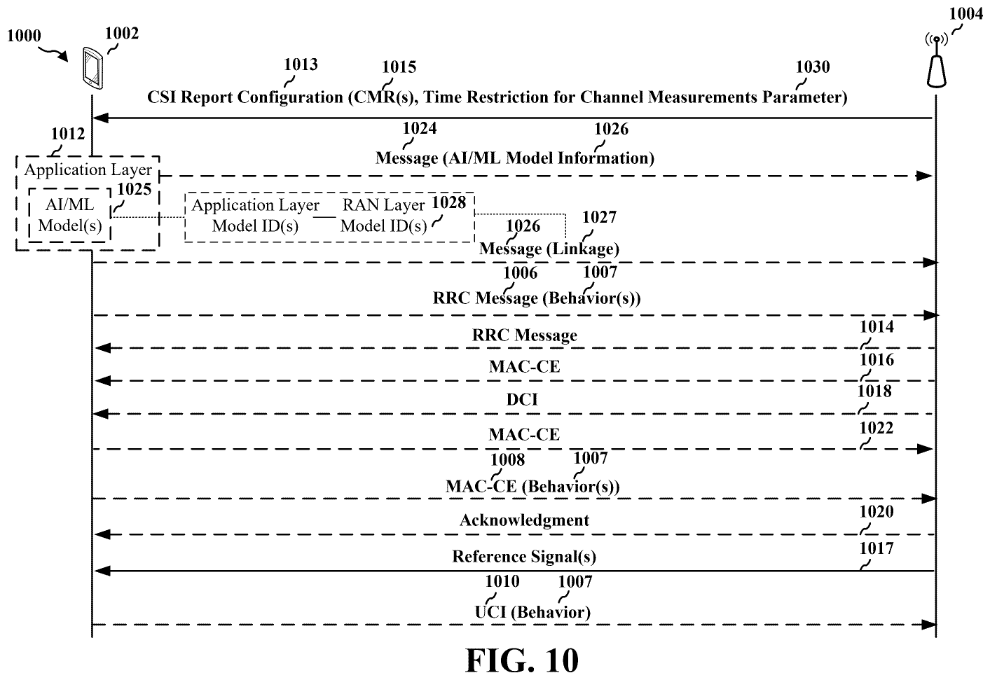

FIG. 10 illustrates an example 1000 of a call flow between a UE 1002 and a base station 1004, in which the UE 1002 may report its L1-RSRP/L1-SINR calculation scheme(s) or behavior(s) 1007 via an RRC message 1006, a MAC-CE 1008, UCI 1010, or an application layer 1012. The UE may report its L1-RSRP/L1-SINR measurements in a CSI report (e.g., in UCI 1010) according to a CSI report configuration 1013 received from base station 1004. For instance, the CSI report configuration 1013 may indicate one or more CMRs 1015 indicating resource information of the reference signal(s) that the UE 1002 will measure for the CSI report (e.g., SSB, CSI-RS), a report configuration type indicating the scheduling method of the report (e.g., periodic, semi-persistent, or aperiodic), a report quantity indicating the measurement(s) the UE 1002 will perform for CMR(s) 1015 (e.g., L1-RSRP of SSB or CRI, or L1-SINR of SSB or CRI), a report frequency configuration indicating the reporting granularity in the frequency domain (e.g., wideband or subband), a time restriction for channel measurements, a time restriction for interference measurements, a codebook configuration, and other parameters. Following receipt of the CSI report configuration 1013, the UE 1002 may receive one or more reference signals 1017 (e.g., SSBs, CSI-RSs) associated with the CMR(s) 1015 (e.g., in respective transmission beams), the UE 1002 may perform instantaneous or filtered measurements of the reference signal(s) 1017 to obtain signal quality metric(s) (e.g., L1-RSRP, L1-SINR) according to its reported behavior(s) 1007, and the UE 1002 may subsequently provide the signal quality metric(s) in the CSI report (e.g., in UCI 1010) to the base station 1004.

Moreover, the UE 1002 may provide in the CSI report (e.g., in UCI 1010) any of the quantities described above with respect to FIGS. 8 and 9. For example, the UCI 1010 may include a time instance or reception beam associated with an instantaneous measurement of one of the reference signals 1017 (e.g., time interval 812 or reception beam 804). Additionally or alternatively, the UCI 1010 may include filtering information associated with a filtered measurement of multiple ones of the reference signals 1017. The filtering information may include, for example, a time window associated with the filtered measurement (e.g., time interval 912, 913), a plurality of time instances or reception beams associated with the filtered measurement (e.g., respective time intervals 922 or reception beams 904), information associated with different CMRs than the CMR 1015 associated with the filtered measurement (e.g., the CMRs in different transmission beams 924), analytical filtering parameters (e.g., averaging or weighted averaging coefficients or weights), and/or ML model information (e.g., inputs, outputs, neural network parameters, or other information regarding ML models 502). Alternatively or additionally, any of the aforementioned quantities may be provided to the base station 1004 via RRC message 1006, MAC-CE 1008, or application layer 1012.

In one aspect, the UE may report, in RRC message 1006, behaviors 1007 from which the UE's L1-RSRP/L1-SINR report(s) may be based. For instance, these behavior(s) 1007 may include any of the L1-RSRP/L1-SINR calculation schemes or quantities described above with respect to FIGS. 8 and 9. For example, the reported behavior(s) may include that the UE performs instantaneous time measurements to obtain instantaneous L1-RSRPs, temporal filtering measurements to obtain filtered L1-RSRPs, spatial filtering measurements to obtain filtered L1-RSRPs, analytical filtering measurements to obtain filtered L1-RSRPs, AI/ML filtering measurements to obtain filtered L1-RSRPs, or any of the above calculation schemes for different combinations of scenarios. Such scenarios may include, for example, a total number of CMRs associated with the L1-RSRP/L1-SINR report, a periodicity of the CMRs associated with the L1-RSRP/L1-SINR report, a total number of reported L1-RSRPs/L1-SINRs in the report, a type of the report (whether periodic, semi-persistent, or aperiodic), and whether the reported quantity is an L1-RSRP or an L1-SINR.

Thus, the UE 1002 may report via RRC message 1006 what are its actual behavior(s) (e.g., whether the UE performs instantaneous measurements or obtains filtered measurements using certain type(s) of filtering), as well as what scenarios its behavior(s) may be dependent upon (e.g., the total number of configured CMRs being a certain value, the CMR periodicity being a certain value, the total number of reported signal quality metrics being a certain value, the report type being periodic, the report type being semi-persistent, the report type being aperiodic, the report quantity being L1-RSRP, or the report quantity being L1-SINR). The behavior(s) may also indicate conditions the UE is to consider during filtering, such as a number of time instances/occasions (e.g., the past five occasions or the past ten occasions) or transmission beams (e.g., the neighboring eight beams or the neighboring two beams). The UE may transmit these behavior(s) 1007 within a UE capability report (e.g., RRC message 1006 is a UE capability report in this example). For instance, if the UE is applying a filtering process to obtain its L1-RSRP measurements, this process may involve fixed instructions or code in firmware without applying adaptive alternations, and thus the UE may report its filtering scheme applied (e.g., temporal filtering, spatial filtering, analytical filtering, AI/ML filtering) once via a UE capability report since this filtering scheme may be static in nature.

In one example, when the UE 1002 reports its behaviors 1007 in RRC message 1006, the UE 1002 may assume that its reported behaviors will be applied in L1-RSRP or L1-SINR measurements. For instance, if the UE 1002 reports that it performs temporal filtering or spatial filtering, then without further signaling between the UE 1002 and the base station 1004, the UE 1002 will proceed to apply this reported behavior for any subsequent L1-RSRP or L1-SINR report. This approach allows for minimal overhead. In another example, if the UE 1002 reports multiple behaviors 1007, the base station 1004 may indicate via an RRC message 1014, a MAC-CE 1016, or DCI 1018 which behavior(s) the UE is to apply for a certain L1-RSRP/L1-SINR report. This approach allows the base station 1004 to have some control over the calculation scheme the UE 1002 is to apply to a certain report, which control may be beneficial for example if such scheme effects AI/ML beam prediction model performance at the base station. In a further example, the base station 1004 may indicate to the UE 1002 to activate one or more of the UE's reported behaviors or calculation schemes in association with different ones of the aforementioned scenarios. For example, the base station 1004 may instruct the UE 1002 to apply one behavior for a scenario where the total number of CMRs is greater than or equal to 32 and the periodicity of the CMRs is less than 5 ms, to apply a different behavior for another scenario where the total number of CMRs is less than 32 and the periodicity of the CMRs is less than 5 ms, and to apply another behavior for a different scenario where the periodicity of the CMRs is greater than or equal to 5 ms. In an additional example where the UE 1002 reports multiple behaviors 1007 in RRC message 1006, the base station 1004 may transmit MAC-CE 1016 or DCI 1018 indicating one of these behaviors or options for the UE to apply to a configured number of consecutive L1-RSRP/L1-SINR reports.

In another aspect, the UE 1002 may report one or more behavior(s) 1007 (e.g., any of the L1-RSRP/L1-SINR calculation schemes or quantities described above with respect to FIGS. 8 and 9) in MAC-CE 1008. In one example, the UE 1002 may apply its reported behaviors for L1-RSRP or L1-SINR measurements after waiting for confirmation from the base station 1004 that the base station 1004 received the MAC-CE 1008. For instance, the base station 1004 may transmit an acknowledgment 1020 to the UE 1002 indicating that the base station 1004 successfully received the MAC-CE 1008 including behavior(s) 1007, and the UE 1002 may apply one or more of its behaviors 1007 to its L1-RSRP/L1-SINR reporting in response to the acknowledgment 1020. Optionally, the UE may wait for a period of time after receiving the acknowledgment 1020 before applying the reported behaviors. This period of time (e.g., in ms) may be based on a pre-defined timer, similar to an activation timer associated with MAC-CE activation commands.

In one example, when the UE reports one or more behavior(s) 1007 in the MAC-CE 1008, these behavior(s) may override behavior(s) 1007 that the UE previously reported in the RRC message 1006 or in a previous MAC-CE 1022. For instance, if the UE 1002 previously indicated in RRC message 1006 or previous MAC-CE 1022 that it intends to perform instantaneous L1-RSRP measurements for CSI reports, but the UE 1002 indicates in MAC-CE 1008 that it intends to perform filtered L1-RSRP measurements for CSI reports, the UE 1002 will apply filtering for subsequent L1-RSRP reporting due to the override by MAC-CE 1008. Thus, UE 1002 may perform one behavior for L1-RSRP/L1-SINR reporting until the UE 1002 sends and optionally receives confirmation from the base station 1004 of MAC-CE 1008, after which the UE 1002 may perform a different behavior for L1-RSRP/L1-SINR reporting.

In another example where the UE 1002 reported multiple behaviors 1007 via RRC message 1006, the MAC-CE 1008 may choose one or more of these behaviors 1007 for subsequent L1-RSRP/L1-SINR reporting. Furthermore, if the MAC-CE 1008 chooses a plurality of behaviors from the multiple behaviors 1007 reported via RRC message 1006, the UE 1002 may further down select one of them for associated L1-RSRP/L1-SINR reporting by indicating in the CSI report itself (e.g., in UCI 1010) the single behavior that the UE 1002 applies for the L1-RSRP/L1-SINR measurements. As an example, the UE 1002 may indicate in RRC message 1006 or in a previous MAC-CE 1022 that it supports three behaviors including instantaneous L1-RSRP measurements, temporarily filtered L1-RSRP measurements, and spatially filtered L1-RSRP measurements, the UE 1002 may later indicate in MAC-CE 1008 that it intends to apply two of these three behaviors including the temporarily and spatially filtered L1-RSRP measurements, and the UE 1002 may additionally indicate in UCI 1010 that the UE applied one of these remaining two behaviors, namely spatial filtering, to obtain the filtered L1-RSRP reported in UCI 1010. In this way, the UE 1002 may effectively indicate the calculation scheme applied to its L1-RSRP/L1-SINR measurements in real-time, further assisting the base station in reliably performing beam prediction.

In a further aspect, the UE 1002 may report one or more behavior(s) 1007 (e.g., any of the L1-RSRP/L1-SINR calculation schemes or quantities described above with respect to FIGS. 8 and 9) in UCI 1010. For instance, the UE 1002 may indicate whether it performed an instantaneous L1-RSRP/L1-SINR measurement or a filtered L1-RSRP/L1-SINR measurement for a respective L1-RSRP/L1-SINR carried in a respective CSI report. Thus, the behavior 1007 the UE 1002 applied to measure the L1-RSRP/L1-SINR indicated in UCI 1010 may itself be indicated in that same UCI carrying the CSI report.

In one example, the UE 1002 may report in UCI 1010 only the behavior(s) 1007 that were adaptively changed or different from the behavior(s) 1007 that the UE 1002 previously reported via RRC message 1006 or MAC-CE 1008. For instance, the UCI 1010 may include a bitmap indicating whether or not the UCI 1010 includes adaptively changed behavior(s) associated with respective L1-RSRPs/L1-SINRs, and for those measurements which include adaptively changed behaviors, the UCI 1010 further includes the behavior(s) 1007 associated with those measurements themselves. The number of bits in the bitmap may be equal to the total number of L1-RSRPs/L1-SINRs reported in UCI 1010. For instance, each of the bits in the bitmap may correspond to a different CMR or beam, where ‘0’ indicates the UE 1002 applied a previously reported behavior in RRC message 1006 or MAC-CE 1008 for that corresponding CMR or beam, while ‘1’ indicates the UE 1002 applied a different behavior for that corresponding CMR or beam, or vice-versa. In one example, the UCI 1010 may include a CSI part 1 and a CSI part 2, where the CSI part 2 includes the CSI itself and the CSI part 1 indicates the number of information bits included in CSI part 2, the bitmap is indicated in the CSI part 1, and the adaptively changed behaviors are indicated in the CSI part 2. In another example, the UCI 1010 may include two CSI reports, where the bitmap is indicated in the first CSI report and the adaptively changed behaviors are indicated in the second CSI report. In either case, the adaptively changed behaviors may only apply to the current CSI report instance (e.g., to prevent behavioral ambiguities in the future if the UCI 1010 is not successfully transmitted or received). Thus, for subsequent UCIs associated with different CSI reports, the previously reported behaviors via RRC message 1006 or MAC-CE 1008 may continue to apply by default.

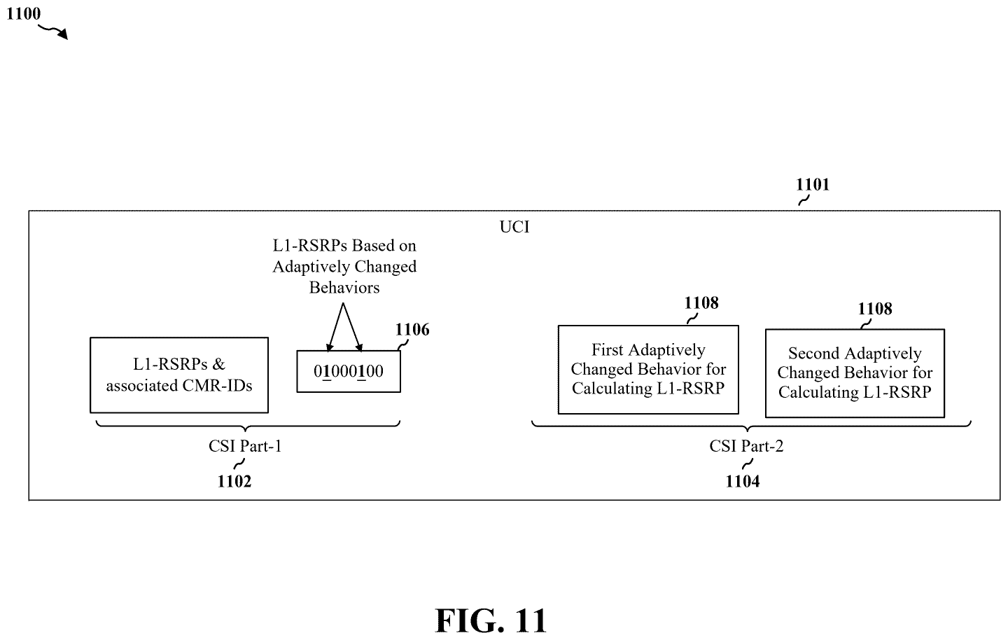

FIG. 11 illustrates an example 1100 of a UCI 1101 (e.g., UCI 1010) including CSI part 1 1102 and CSI part 2 1104, where the UE includes a bitmap 1106 in CSI part 1 and adaptively changed behaviors 1108 in CSI part 2. While the example of FIG. 11 specifically refers to L1-RSRPs, it should be understood that the example similarly applies to L1-SINRs. In the illustrated example, the UE may report a bitmap ‘01000100’ in CSI part 1 indicating that the UE is reporting L1-RSRPs for eight CMRs (one for each bit) and that the UE deviated from its previously reported behavior for the two CMRs indicated with ‘1's. For instance, if the UE previously reported to the base station that it will perform temporal filtering on CMRs to identify L1-RSRPs, then this bitmap may indicate that for those six CMRs with ‘0's the UE performed temporal filtering but for those two CMRs with ‘1's the UE performed a different behavior (e.g., spatial filtering or instantaneous measurements). The UE may subsequently indicate the different behaviors or calculation schemes that were applied for those two respective CMRs in the CSI part 2. For example, the UE may indicate that it performed spatial filtering for the second CMR (the first ‘1’ in bitmap 1106) and instantaneous measurements without filtering for the sixth CMR (the second ‘1’ in bitmap 1106).

Referring back to FIG. 10, rather than incurring additional overhead in UCI 1010 via inclusion of the aforementioned bitmap, the UE 1002 may indicate in the UCI 1010 carrying the L1-RSRPs/L1-SINRs a down-selected behavior of multiple previously reported behavior options via RRC message 1006 or MAC-CE 1008 which the UE applied to obtain the associated L1-RSRPs/L1-SINRs. As an example, the UE 1002 may indicate in RRC message 1006 or in MAC-CE 1008 that it supports two behaviors including temporarily filtered L1-RSRP measurements and spatially filtered L1-RSRP measurements, and the UE 1002 may later indicate in UCI 1010 that the UE applied one of these two behaviors, namely spatial filtering, to obtain the filtered L1-RSRPs reported in UCI 1010. For instance, the UCI 1010 may include a bitmap in CSI part 1 or CSI part 2 (similar to bitmap 1106 in FIG. 11) which indicates the behavior 1007 the UE 1002 selected to apply to obtain the reported L1-RSRPs.

In an additional aspect, the UE 1002 may report one or more behavior(s) 1007 (e.g., any of the L1-RSRP/L1-SINR calculation schemes or quantities described above with respect to FIGS. 8 and 9) via an application layer protocol (e.g., file transfer protocol (FTP) or other message sharing protocol) from application layer 1012 of UE 1002. This approach may significantly reduce the number of bits the UE 1002 may otherwise use to report or indicate its behavior(s) 1007 at the RRC (L3), MAC (L2), or PHY (L1) layers, especially in connection with behavior(s) involving AI/ML models (e.g., AI/ML filtering). For instance, the UE 1002 may transmit a message 1024 via an application layer protocol including information regarding one or more AI/ML models 1025 that the UE 1002 may apply for L1-RSRP/L1-SINR filtering (where AI/ML filtering is the behavior 1007 in this example). Moreover, since there may be a significant amount of AI/ML model information transferred via application layer protocols for various use cases and separate indexing methods for these AI/ML models 1025 in the application layer and a RAN layer (L1/L2/L3), the UE 1002 may also transmit another message 1026 (e.g., via an RRC message or MAC-CE) indicating a linkage 1027 of the AI/ML model(s) 1025 to respective model identifiers 1028 applied in a RAN layer (L1/L2/L3). For instance, the linkage 1027 may map application layer IDs for respective AI/ML models with respective RAN layer IDs for those AI/ML models.

Afterwards, the UE 1002 may indicate in RRC message 1006, MAC-CE 1008, or the UCI 1010 including the reported L1-RSRPs/L1-SINRs, the model identifier 1028 of the previously reported AI/ML model(s) 1025 which the UE applies for its L1-RSRP/L1-SINR measurements. Thus, the behavior(s) 1007 the UE reports via RRC message 1006, MAC-CE 1008, UCI 1010 (or other message as described above) may be indicated via the respective model identifier 1028, which may inform base station 1004 that the UE is applying AI/ML filtering using the AI/ML model associated with that model identifier. Moreover, the UE 1002 may report its various AI/ML model details via the application layer 1012 but indicate using a small number of bits in a RAN layer (L1/L2/L3) which AI/ML model the UE 1002 is actually applying for its AI/ML filtering (e.g., via a down-selection), thereby saving significant communication overhead at the RAN layers.

As previously noted, the CSI report configuration 1013 may indicate a time restriction for channel measurements parameter 1030 (e.g., via the name timeRestrictionForChannelMeasurements or another name). This parameter 1030 may allow the UE 1002 to determine which CSI-RS is to be measured for a specific report, and may be set with a value of configured or not configured. If the parameter 1030 is set as configured, the CSI report configuration 1013 indicates the UE 1002 to derive the channel measurements for computing CSI reported in an uplink slot based on only the most recent, no later than the CSI reference resource, occasion of a non-zero power (NZP) CSI-RS associated with the CSI resource setting. Thus, when this parameter 1030 is configured, the behavior(s) 1007 which the UE 1002 may apply to its L1-RSRP/L1-SINR reporting may be limited to instantaneous measurements. In contrast, if the parameter 1030 is set as not configured, the CSI report configuration 1013 indicates the UE 1002 to derive the channel measurements for computing CSI values reported in an uplink slot based on only the NZP CSI-RS, no later than the CSI reference resource, associated with the CSI resource setting. Thus, when this parameter 1030 is not configured, the behavior(s) 1007 which the UE 1002 may apply to its L1-RSRP/L1-SINR reporting may not be limited to instantaneous measurements; for example, the UE 1002 may at its option apply filtering as previously described. Thus, when the parameter 1030 is set to not configured, the UE 1002 may perform any of aforementioned behavior reporting via any of the RRC message 1006, MAC-CE 1008, UCI 1010, application layer 1012, or other messages described above, without restriction on the behavior(s) 1007 that can be applied.

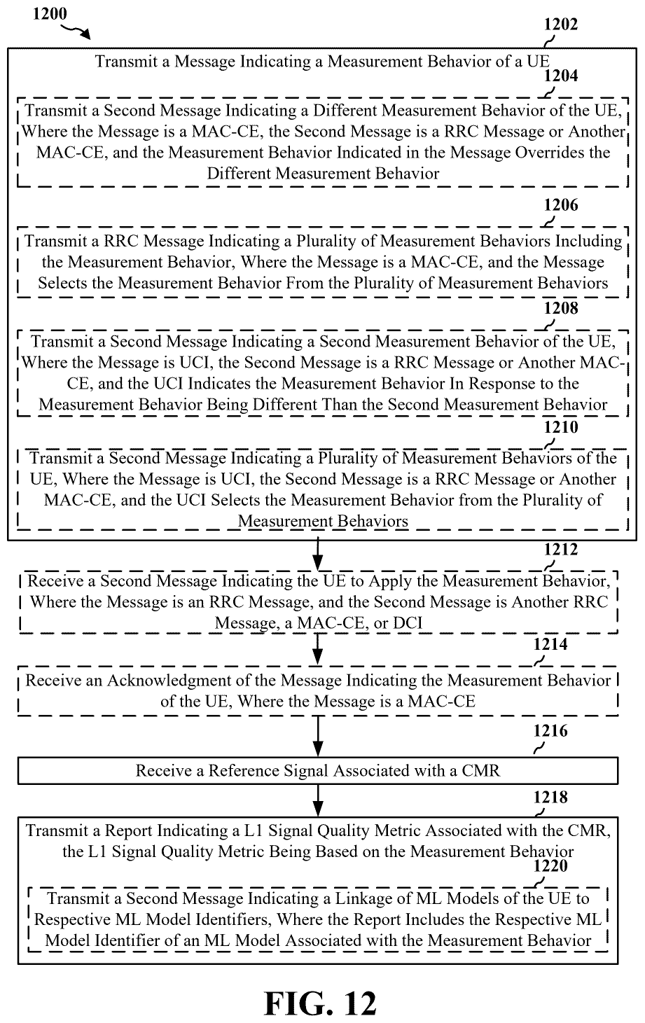

FIG. 12 is a flowchart 1200 of a method of wireless communication. The method may be performed by a UE (e.g., the UE 104, 350, 1002; the apparatus 1302). Optional aspects are illustrated in dashed lines. The method allows a UE to provide detailed reporting to a base station (e.g., the base station 102/180, 310, 1004) regarding the UE's measurement behaviors or calculation schemes that the UE applied to determine its signal quality measurements (e.g., L1-RSRPs or L1-SINRs), thereby allowing the base station to have a more reliable collection of data for base station-based beam prediction or other AI/ML-based beam management.

At 1202, the UE may transmit a message indicating a measurement behavior of the UE. For example, 1202 may be performed by message component 1340. In one example, the message indicating the measurement behavior at 1202 may be a RRC message. In another example, the message indicating the measurement behavior at 1202 may be a MAC-CE. In a further example, the message indicating the measurement behavior at 1202 may be UCI. In an additional example, the message indicating the measurement behavior may be transmitted at 1202 in an application layer of the UE. For instance, referring to FIG. 10, the UE 1002 may report to base station 1004 its L1-RSRP/L1-SINR calculation scheme(s) or behavior(s) 1007 via an RRC message 1006, a MAC-CE 1008, UCI 1010, or message 1024 via application layer 1012.

The measurement behavior may be at least one of: a first behavior in which the UE performs instantaneous measurements of CMRs at respective time instances to obtain L1signal quality metrics; a second behavior in which the UE performs filtering on measurements of the CMRs to obtain the L1signal quality metrics, the filtering being one or more of temporal filtering, spatial filtering, analytical filtering, or ML based filtering; or a third behavior in which the UE performs the instantaneous measurements or the filtering based on one or more parameters, the one or more parameters including a total quantity of the CMRs, a periodicity of the CMRs, a total quantity of the L1signal quality metrics, a periodic CMR type, a semi-persistent CMR type, an aperiodic CMR type, a reference signal receive power (RSRP) report quantity, or a signal to noise and interference ratio (SINR) report quantity. For instance, referring to FIG. 10, the UE 1002 may report, in RRC message 1006, MAC-CE 1008, UCI 1010, or via application layer 1012, behaviors 1007 from which the UE's L1-RSRP/L1-SINR report(s) may be based. For instance, these behavior(s) 1007 may include any of the L1-RSRP/L1-SINR calculation schemes or quantities described above with respect to FIGS. 8 and 9. For example, the reported behavior(s) may include that the UE performs instantaneous time measurements to obtain instantaneous L1-RSRPs, temporal filtering measurements to obtain filtered L1-RSRPs, spatial filtering measurements to obtain filtered L1-RSRPs, analytical filtering measurements to obtain filtered L1-RSRPs, AI/ML filtering measurements to obtain filtered L1-RSRPs, or any of the above calculation schemes for different combinations of scenarios. Such scenarios may include, for example, a total number of CMRs associated with the L1-RSRP/L1-SINR report, a periodicity of the CMRs associated with the L1-RSRP/L1-SINR report, a total number of reported L1-RSRPs/L1-SINRs in the report, a type of the report (whether periodic, semi-persistent, or aperiodic), and whether the reported quantity is an L1-RSRP or an L1-SINR.

In one example where the message indicating the measurement behavior at 1202 is an RRC message, the RRC message may include a plurality of measurement behaviors including the measurement behavior. For instance, referring to FIG. 10, when the UE 1002 reports its behaviors 1007 in RRC message 1006, the UE 1002 may assume that its reported behaviors will be applied in L1-RSRP or L1-SINR measurements. The UE may report such multiple behaviors 1007 in RRC message 1006.

At 1204, in one example where the message indicating the measurement behavior at 1202 is a MAC-CE, the UE may transmit a second message indicating a different measurement behavior of the UE, the second message being a RRC message or another MAC-CE. For example, 1204 may be performed by message component 1340. In such case, the measurement behavior indicated in the MAC-CE at 1202 may override the different measurement behavior indicated in the second message at 1204. For instance, referring to FIG. 10, when the UE 1002 reports one or more behavior(s) 1007 in the MAC-CE 1008 (the message), these behavior(s) may override behavior(s) 1007 that the UE previously reported in the RRC message 1006 or in a previous MAC-CE 1022 (either being an example of the second message). For instance, if the UE 1002 previously indicated in RRC message 1006 or previous MAC-CE 1022 that it intends to perform instantaneous L1-RSRP measurements for CSI reports, but the UE 1002 indicates in MAC-CE 1008 that it intends to perform filtered L1-RSRP measurements for CSI reports, the UE 1002 will apply filtering for subsequent L1-RSRP reporting due to the override by MAC-CE 1008.

At 1206, in one example where the message indicating the measurement behavior at 1202 is a MAC-CE, the UE may transmit a RRC message indicating a plurality of measurement behaviors including the measurement behavior. For example, 1206 may be performed by message component 1340. In such case, the MAC-CE transmitted at 1202 may select the measurement behavior from the plurality of measurement behaviors. For instance, referring to FIG. 10, where the UE 1002 reported multiple behaviors 1007 via RRC message 1006, the MAC-CE 1008 may choose one or more of these behaviors 1007 for subsequent L1-RSRP/L1-SINR reporting.

At 1208, in one example where the message indicating the measurement behavior at 1202 is UCI, the UE may transmit a second message indicating a second measurement behavior of the UE, where the second message may be a RRC message or another MAC-CE. For example, 1208 may be performed by message component 1340. In such case, the UCI may indicate the measurement behavior at 1202 in response to the measurement behavior being different than the second measurement behavior indicated at 1208. For instance, referring to FIGS. 10 and 11, the UE 1002 may report in UCI 1010 (the message in this example) only the behavior(s) 1007 that were adaptively changed or different from the behavior(s) 1007 that the UE 1002 previously reported via RRC message 1006 or MAC-CE 1008 (either being an example of the second message). For instance, the UCI 1010, 1101 may include bitmap 1106 indicating whether or not the UCI 1010, 1101 includes adaptively changed behavior(s) 1108 associated with respective L1-RSRPs/L1-SINRs, and for those measurements which include adaptively changed behaviors 1108, the UCI 1010, 1101 further includes the behavior(s) 1007 associated with those measurements themselves.

At 1210, in one example where the message indicating the measurement behavior at 1202 is UCI, the UE may transmit a second message indicating a plurality of measurement behaviors of the UE, where the second message is a RRC message or another MAC-CE. For example, 1210 may be performed by message component 1340. In such case, the UCI transmitted at 1202 may select the measurement behavior from the plurality of measurement behaviors. For instance, referring to FIG. 10, the UE 1002 may indicate in the UCI 1010 carrying the L1-RSRPs/L1-SINRs a down-selected behavior of multiple previously reported behavior options via RRC message 1006 or MAC-CE 1008 (examples of the second message) which the UE applied to obtain the associated L1-RSRPs/L1-SINRs. As an example, the UE 1002 may indicate in RRC message 1006 or in MAC-CE 1008 that it supports two behaviors including temporarily filtered L1-RSRP measurements and spatially filtered L1-RSRP measurements, and the UE 1002 may later indicate in UCI 1010 that the UE applied one of these two behaviors, namely spatial filtering, to obtain the filtered L1-RSRPs reported in UCI 1010.

At 1212, in one example where the message indicating the measurement behavior at 1202 is an RRC message, the UE may receive a second message indicating the UE to apply the measurement behavior, where the second message is another RRC message, a MAC-CE, or DCI. For example, 1212 may be performed by message component 1340. For instance, referring to FIG. 10, if the UE 1002 reports multiple behaviors 1007, the base station 1004 may indicate via an RRC message 1014, a MAC-CE 1016, or DCI 1018 which behavior(s) the UE is to apply for a certain L1-RSRP/L1-SINR report. In a further example, the base station 1004 may indicate to the UE 1002 to activate one or more of the UE's reported behaviors or calculation schemes in association with different ones of the aforementioned scenarios. For example, the base station 1004 may instruct the UE 1002 to apply one behavior for a scenario where the total number of CMRs is greater than or equal to 32 and the periodicity of the CMRs is less than 5 ms, to apply a different behavior for another scenario where the total number of CMRs is less than 32 and the periodicity of the CMRs is less than 5 ms, and to apply another behavior for a different scenario where the periodicity of the CMRs is greater than or equal to 5 ms. In an additional example where the UE 1002 reports multiple behaviors 1007 in RRC message 1006, the base station 1004 may transmit MAC-CE 1016 or DCI 1018 indicating one of these behaviors or options for the UE to apply to a configured number of consecutive L1-RSRP/L1-SINR reports.

At 1214, in one example where the message indicating the measurement behavior at 1202 is MAC-CE, the UE may receive an acknowledgment of the MAC-CE, where the L1 signal quality metric being based on the measurement behavior at 1218 is based on the acknowledgment. For example, 1214 may be performed by message component 1340. For instance, referring to FIG. 10, the UE 1002 may apply its reported behaviors for L1-RSRP or L1-SINR measurements after waiting for confirmation from the base station 1004 that the base station 1004 received the MAC-CE 1008. For instance, the base station 1004 may transmit an acknowledgment 1020 to the UE 1002 indicating that the base station 1004 successfully received the MAC-CE 1008 including behavior(s) 1007, and the UE 1002 may apply one or more of its behaviors 1007 to its L1-RSRP/L1-SINR reporting in response to the acknowledgment 1020. Optionally, the UE may wait for a period of time after receiving the acknowledgment 1020 before applying the reported behaviors.

At 1216, the UE may receive a reference signal associated with a CMR. For example, 1216 may be performed by reference signal component 1342. For instance, referring to FIG. 10, the UE 1002 may receive CSI report configuration 1013 including one or more CMRs 1015 indicating resource information of the reference signal(s) that the UE 1002 will measure for the CSI report (e.g., SSB, CSI-RS). Following receipt of the CSI report configuration 1013, the UE 1002 may receive one or more reference signals 1017 (e.g., SSBs, CSI-RSs) associated with the CMR(s) 1015 (e.g., in respective transmission beams).

At 1218, the UE may transmit a report indicating a layer 1 (L1) signal quality metric associated with the CMR, the L1 signal quality metric being based on the measurement behavior (indicated at 1202). For example, 1218 may be performed by report component 1344. The L1 signal quality metric may be, for example, L1-RSRP or L1-SINR. For instance, referring to FIG. 10, the UE 1002 may perform instantaneous or filtered measurements of the reference signal(s) 1017 to obtain signal quality metric(s) (e.g., L1-RSRP, L1-SINR) according to its reported behavior(s) 1007, and the UE 1002 may subsequently provide the signal quality metric(s) in a CSI report (e.g., in UCI 1010) to the base station 1004. Thus, in one example where the message indicating the measurement behavior at 1202 is UCI, the UCI further includes the report at 1218 indicating the L1 signal quality metric associated with the measurement behavior. Moreover, the UE 1002 may provide in the CSI report (e.g., in UCI 1010) any of the quantities described above with respect to FIGS. 8 and 9. For example, the UCI 1010 may include a time instance or reception beam associated with an instantaneous measurement of one of the reference signals 1017 (e.g., time interval 812 or reception beam 804). Additionally or alternatively, the UCI 1010 may include filtering information associated with a filtered measurement of multiple ones of the reference signals 1017. The filtering information may include, for example, a time window associated with the filtered measurement (e.g., time interval 912, 913), a plurality of time instances or reception beams associated with the filtered measurement (e.g., respective time intervals 922 or reception beams 904), information associated with different CMRs than the CMR 1015 associated with the filtered measurement (e.g., the CMRs in different transmission beams 924), analytical filtering parameters (e.g., averaging or weighted averaging coefficients or weights), and/or ML model information (e.g., inputs, outputs, neural network parameters, or other information regarding ML models 502). Alternatively or additionally, any of the aforementioned quantities may be provided to the base station 1004 via RRC message 1006, MAC-CE 1008, or application layer 1012.

In one example where the message indicating the measurement behavior at 1202 is transmitted via an application layer of the UE, the measurement behavior may indicate that the L1 signal quality metric is a filtered measurement output from a ML model of the UE. For instance, referring to FIG. 10, the UE 1002 may transmit message 1024 via an application layer protocol including information regarding one or more AI/ML models 1025 that the UE 1002 may apply for L1-RSRP/L1-SINR filtering (where AI/ML filtering is the behavior 1007 in this example and the filtered L1-RSRP/L1-SINR is an output from the one or more AI/ML models 1025).

At 1220, in one example where the message indicating the measurement behavior at 1202 is transmitted via an application layer of the UE, the message may further indicate a plurality of ML models of the UE, and the UE may transmit a second message indicating a linkage of the ML models to respective ML model identifiers. For example, 1220 may be performed by message component 1340. In such case, the report at 1218, which may be transmitted in an RRC message, a MAC-CE, or UCI, may include the respective ML model identifier of the ML model associated with the measurement behavior. For instance, referring to FIG. 10, the UE 1002 may also transmit another message 1026 (e.g., via an RRC message or MAC-CE) indicating a linkage 1027 of the AI/ML model(s) 1025 indicated in message 1024 to respective model identifiers 1028 applied in a RAN layer (L1/L2/L3). For instance, the linkage 1027 may map application layer IDs for respective AI/ML models with respective RAN layer IDs for those AI/ML models. Afterwards, the UE 1002 may indicate in RRC message 1006, MAC-CE 1008, or the UCI 1010 including the reported L1-LRSRPs/L1-SINRs, the model identifier 1028 of the previously reported AI/ML model(s) 1025 which the UE applies for its L1-RSRP/L1-SINR measurements. Thus, the behavior(s) 1007 the UE reports via RRC message 1006, MAC-CE 1008, UCI 1010 (or other message as described above) may be indicated via the respective model identifier 1028, which may inform base station 1004 that the UE is applying AI/ML filtering using the AI/ML model associated with that model identifier.

In one example, the report transmitted at 1218 may be associated with a CSI report configuration indicating a time restriction for channel measurements, and the L1 signal quality metric being based on the measurement behavior may be based on the time restriction being not configured. For instance, referring to FIG. 10, the UE may report its L1-RSRP/L1-SINR measurements in a CSI report (e.g., in UCI 1010) according to a CSI report configuration 1013 received from base station 1004, where the CSI report configuration 1013 indicates a time restriction for channel measurements parameter 1030. If the parameter 1030 is set as not configured, the CSI report configuration 1013 indicates the UE 1002 to derive the channel measurements for computing CSI values reported in an uplink slot based on only the NZP CSI-RS, no later than the CSI reference resource, associated with the CSI resource setting. Thus, when this parameter 1030 is not configured, the behavior(s) 1007 which the UE 1002 may apply to its L1-RSRP/L1-SINR reporting may not be limited to instantaneous measurements; for example, the UE 1002 may at its option apply filtering as previously described. Thus, when the parameter 1030 is set to not configured, the UE 1002 may perform any of aforementioned behavior reporting via any of the RRC message 1006, MAC-CE 1008, UCI 1010, application layer 1012, or other messages described above, without restriction on the behavior(s) 1007 that can be applied.

In a first aspect, the measurement behavior indicated at 1202 may indicate that the L1 signal quality metric is associated with an instantaneous measurement of the CMR at a time instance. For instance, referring to FIGS. 8 and 10, the behavior(s) 1007 indicated in the RRC message 1006, MAC-CE 1008, or UCI 1010 may indicate that the CSI report 810 (e.g., UCI 1010) includes instantaneous L1-RSRP measurement 808 at time instance 806.

In one example of the first aspect, the report at 1218 may further indicate the time instance. For instance, referring to FIGS. 8 and 10, the CSI report 810 (e.g., UCI 1010) may further indicate the time interval 812 between a time 814 when the UE transmits the CSI report 810 and the time instance 806 during which the UE obtained the L1-RSRP measurement 808. Thus, the UE 1002 may report the specific time instance (via time interval 812) associated with the instantaneous measurement to assist the base station in more reliably performing beam prediction.

In another example of the first aspect, the report at 1218 may further indicate a reception beam associated with the instantaneous measurement. For instance, referring to FIG. 8, if the reception beam 804 by which UE receives CMR #3 at time instance 806 is Rx-beam #8, the UE may report information associated with Rx-beam #8 in the CSI report 810 to the base station. For instance, the UE may report an identifier associated with the reception beam, an identifier of a panel including an antenna associated with the reception beam, or an identifier associated with a polarization of a signal received via the reception beam. These identifiers, in turn, may be further based on a UE pre-reported capability and associated base station configuration for defining such identifiers. Moreover, the UE may report a direction towards which the reception beam points, and/or orientation information of the UE, at the time instance.

In a second aspect, the measurement behavior indicated at 1202 may indicate that the L1 signal quality metric is a filtered measurement. For instance, referring to FIGS. 9 and 10, the behavior(s) 1007 indicated in the RRC message 1006, MAC-CE 1008, or UCI 1010 may indicate that the CSI report 910 (e.g., UCI 1010) includes a filtered L1-RSRP from L1-RSRP measurements 908.

In one example of the second aspect, the report at 1218 may further indicate filtering information associated with the filtered measurement. For instance, referring to FIGS. 9 and 10, the CSI report 910 (e.g., UCI 1010) may further indicate information regarding the specific filtering scheme applied to obtain the filtered L1-RSRP from L1-RSRP measurements 908. For instance, the filtering information may indicate whether temporal filtering, spatial filtering, analytical filtering, or AI/ML filtering was applied.

In one example of filtering information, the filtering information may indicate a time window associated with the filtered measurement. For instance, referring to FIGS. 9 and 10, the CSI report 910 may further include a time interval 912, 913 between a time 914 when the UE transmits the CSI report 910 and either a start time 916 (corresponding to time interval 912) or an end time 918 (corresponding to time interval 913) of a time window 920 during which the UE 1002 obtained the L1-RSRP measurements 908. Thus, the UE 1002 may report the specific time window (via time interval 912, 913) associated with the temporally filtered measurement to assist the base station in more reliably performing beam prediction.

In another example of filtering information, the filtering information may indicate a plurality of time instances associated with the filtered measurement. For instance, referring to FIGS. 9 and 10, the CSI report 910 may further include respective time intervals 922 between the time 914 when the UE transmits the CSI report 910 and the respective time instances 906 during which the UE obtained the L1-RSRP measurements 908. Thus, the UE may report the specific time instances (via respective time intervals 922) associated with the temporally filtered measurement to assist the base station in more reliably performing beam prediction.

In another example of filtering information, the filtering information may indicate a reception beam associated with a respective one of the time instances. For instance, referring to FIGS. 9 and 10, in the event the UE 1002 reports specific time instances in which the L1-RSRP/L1-SINR measurement of a CMR was obtained (e.g., via respective time intervals 922), the CSI report 910 may further include information regarding the different reception beam(s) 904 which the UE used to receive the CMR at these time instances. For instance, the UE may report an identifier associated with the reception beam(s), an identifier of a panel including an antenna associated with the reception beam(s), or an identifier associated with a polarization of a signal received via the reception beam(s). These identifiers, in turn, may be further based on a UE pre-reported capability and associated base station configuration for defining such identifiers. Moreover, the UE may report a direction towards which the reception beam(s) points, and/or orientation information of the UE, at the time instances.

In another example of filtering information, the filtering information may include information associated with a different CMR than the CMR associated with the filtered measurement. For instance, referring to FIGS. 9 and 10, the UE 1002 may receive multiple CMRs in different transmission beams 924 within respective periods of time 926 (e.g., corresponding to respective SSB burst sets or CSI-RS resource set instances). Thus, during one of the respective periods of time 926, the UE may not only obtain L1-RSRP measurement 908 of the CMR carried in transmission beam 902 during the corresponding one of the respective time instances 906, but also instantaneous L1-RSRP measurements of the other CMRs carried in the different transmission beams 924 (neighboring beams) during other time instances within the burst set or resource set instance. The UE may then filter these instantaneous L1-RSRP measurements including those associated with these neighboring beams in the same SSB burst set or CSI-RS resource set to obtain a spatially filtered L1-RSRP, and the UE may include this filtered metric in the CSI report 910. Moreover, to assist the base station in more reliably performing beam prediction., the UE may include in the CSI report 910 the identifiers of the CMRs from which the filtered metric was derived, including the CMR carried in the transmission beam 902 and the other CMRs carried in the different transmission beams 924. Additionally, to further assist the base station, the UE may further include in the CSI report 910 the instantaneous L1-RSRP measurements, and/or the specific time window (via time interval(s) 912, 913) or time instances (via respective time interval(s) 922) associated with these instantaneous L1-RSRP measurements, which the UE used to derive the spatially filtered measurement.

In another example of filtering information, the filtering information may include an analytical filtering parameter. For instance, referring to FIGS. 9 and 10, after obtaining the L1-RSRP measurements 908 of the CMR over the respective time instances 906 (e.g., in temporal filtering) and/or the L1-RSRP measurements of other CMRs in different transmission beams 924 (e.g., in spatial filtering), the UE 1002 may filter these L1-RSRP measurements to obtain a filtered L1-RSRP of the CMR(s). To perform this filtering, the UE may apply an analytical method such as averaging the different L1-RSRP measurements, linearly combining or applying weighted averaging to the L1-RSRP measurements, applying nonlinear filtering involving recursive calculations, applying filtering in an AI/ML neural network, or other methods. For example, the UE may apply higher weights to L1-RSRP measurements associated with the same CMR and lower weights to L1-RSRP measurements associated with different CMRs. To assist the base station in more reliably performing beam prediction, the UE 1002 may include in the CSI report 910 information regarding the analytical method applied, for example, whether averaging or weighted averaging was used, and if weighted averaging was used, the different weights that were applied. For example, different filtering algorithms or analytical methods may be associated with different bit values (e.g., one bit value for averaging, another bit value for weighted averaging, different bit values for different weights, different bit values for etc.), and the UE 1002 may report one or more of these bit values in the CSI report 910 accordingly.

In another example of filtering information, the filtering information may indicate a ML model of the UE, and the filtered measurement is an output of the ML model. For instance, referring to FIGS. 9 and 10, if the UE 1002 filters the L1-RSRP measurements 908 of the CMR over the respective time instances 906 (e.g., in temporal filtering) and/or the L1-RSRP measurements of other CMRs in different transmission beams 924 (e.g., in spatial filtering), the UE may input these measurements into an AI/ML model (e.g., AI/ML model 502, 1025) which outputs information associated with the filtered L1-RSRP value. In the CSI report 910, the UE may include the filtered L1-RSRP value, as well as include information regarding the inputs or outputs used for obtaining this filtered L1-RSRP value (e.g., the L1-RSRP measurements or the output information).

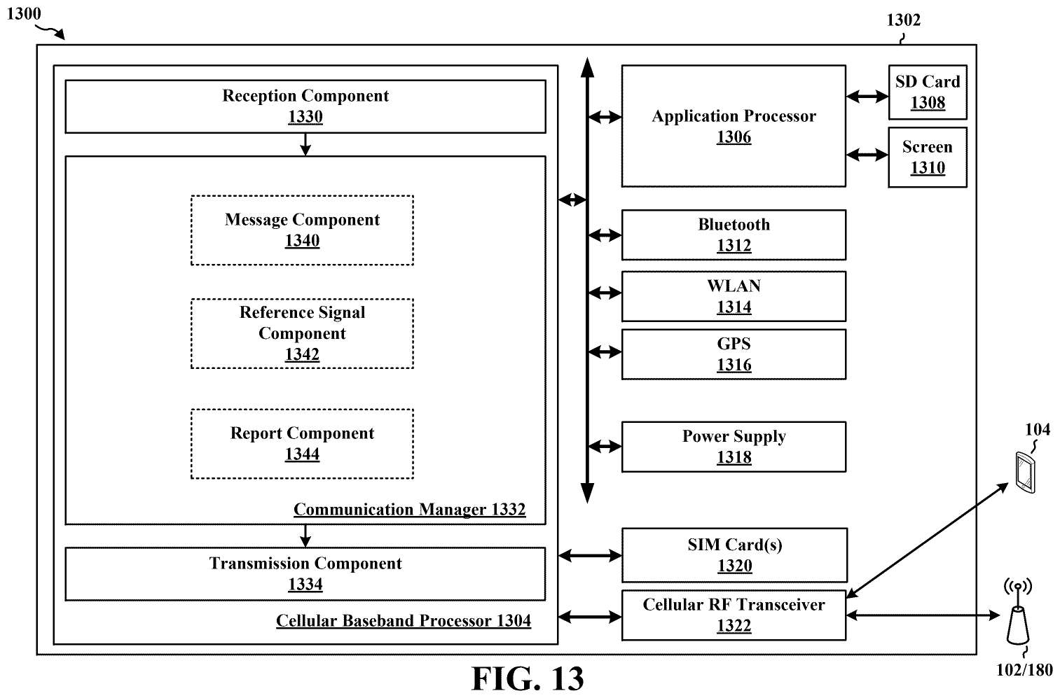

FIG. 13 is a diagram 1300 illustrating an example of a hardware implementation for an apparatus 1302. The apparatus 1302 is a UE and includes a cellular baseband processor 1304 (also referred to as a modem) coupled to a cellular RF transceiver 1322 and one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, and a power supply 1318. The cellular baseband processor 1304 communicates through the cellular RF transceiver 1322 with the UE 104 and/or BS 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304. The cellular baseband processor 1304 may be a component of the UE 350 and may include the memory 360 and/or at least one of the TX processor 368, the RX processor 356, and the controller/processor 359. In one configuration, the apparatus 1302 may be a modem chip and include just the baseband processor 1304, and in another configuration, the apparatus 1302 may be the entire UE (e.g., see 350 of FIG. 3) and include the aforediscussed additional modules of the apparatus 1302.

The communication manager 1332 includes a message component 1340 that is configured to transmit a message indicating a measurement behavior of the apparatus, e.g., as described in connection with 1202. For instance, the controller/processor 359 or the TX processor 368 of UE 104, 350, 1002 may include message component 1340, which may transmit the message to the base station 102/180, 310, 1004 by, for example, mapping coded and modulated symbols of the message to a spatial stream, modulating an RF carrier with the spatial stream, and providing the modulated RF carrier to the base station via antennas 352.

The message component 1340 may be further configured to receive a second message indicating the apparatus to apply the measurement behavior, where the second message is another RRC message, a MAC-CE, or DCI, e.g., as described in connection with 1212. The message component 1340 may be further configured to receive an acknowledgment of the MAC-CE, where the L1 signal quality metric being based on the measurement behavior is based on the acknowledgment, e.g., as described in connection with 1214. The message component 1340 may be further configured to transmit a second message indicating a different measurement behavior of the apparatus, the second message being a RRC message or another MAC-CE,
where the measurement behavior indicated in the MAC-CE overrides the different measurement behavior indicated in the second message, e.g., as described in connection with 1204. The message component 1340 may be further configured to transmit a RRC message indicating a plurality of measurement behaviors including the measurement behavior, where the MAC-CE selects the measurement behavior from the plurality of measurement behaviors, e.g., as described in connection with 1206. The message component 1340 may be further configured to transmit a second message indicating a second measurement behavior of the apparatus, the second message being a RRC message or another MAC-CE, where the UCI indicates the measurement behavior in response to the measurement behavior being different than the second measurement behavior, e.g., as described in connection with 1208. The message component 1340 may be further configured to transmit a second message indicating a plurality of measurement behaviors of the apparatus, the second message being a RRC message or another MAC-CE, where the UCI selects the measurement behavior from the plurality of measurement behaviors, e.g., as described in connection with 1210. The message component 1340 may be further configured to transmit a second message indicating a linkage of the ML models to respective ML model identifiers, e.g., as described in connection with 1220.

The communication manager 1332 further includes a reference signal component 1342 that is configured to receive a reference signal associated with a CMR, e.g., as described in connection with 1216. For instance, the controller/processor 359 or RX processor 356 of UE 104, 350, 1002 may include reference signal component 1342, which may receive the reference signal from the base station 102/180, 310, 1004 by, for example, obtaining via antennas 352 a modulated RF carrier including mapped coded and modulated symbols of the reference signal in a spatial stream, demodulating the spatial stream from the RF carrier, and de-mapping the coded and modulated symbols of the reference signal from the demodulated spatial stream.

The communication manager 1332 further includes a report component 1344 that is configured to transmit a report indicating a L1 signal quality metric associated with the CMR, the L1 signal quality metric being based on the measurement behavior, e.g., as described in connection with 1218. For instance, the controller/processor 359 or the TX processor 368 of UE 104, 350, 1002 may include report component 1344, which may transmit the report to the base station 102/180, 310, 1004 by, for example, mapping coded and modulated symbols of the report to a spatial stream, modulating an RF carrier with the spatial stream, and providing the modulated RF carrier to the base station via antennas 352.

The apparatus may include additional components that perform each of the blocks of the algorithm in the aforementioned flowchart of FIG. 12. As such, each block in the aforementioned flowchart of FIG. 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the cellular baseband processor 1304, includes means for transmitting a message indicating a measurement behavior of the apparatus; and means for receiving a reference signal associated with a channel measurement resource (CMR); wherein the means for transmitting is further configured to transmit a report indicating a layer 1 (L1) signal quality metric associated with the CMR, the L1 signal quality metric being based on the measurement behavior.

In one configuration, the means for receiving may be further configured to receive a second message indicating the apparatus to apply the measurement behavior, where the second message is another RRC message, a MAC-CE, or DCI.

In one configuration, the means for receiving may be further configured to receive an acknowledgment of the MAC-CE, where the LI signal quality metric being based on the measurement behavior is based on the acknowledgment.

In one configuration, the means for transmitting may be further configured to transmit a second message indicating a different measurement behavior of the apparatus, the second message being a RRC message or another MAC-CE, where the measurement behavior indicated in the MAC-CE overrides the different measurement behavior indicated in the second message.

In one configuration, the means for transmitting may be further configured to transmit a RRC message indicating a plurality of measurement behaviors including the measurement behavior, where the MAC-CE selects the measurement behavior from the plurality of measurement behaviors.

In one configuration, the means for transmitting may be further configured to transmit a second message indicating a second measurement behavior of the apparatus, the second message being a RRC message or another MAC-CE, where the UCI indicates the measurement behavior in response to the measurement behavior being different than the second measurement behavior.

In one configuration, the means for transmitting may be further configured to transmit a second message indicating a plurality of measurement behaviors of the apparatus, the second message being a RRC message or another MAC-CE, where the UCI selects the measurement behavior from the plurality of measurement behaviors.

In one configuration, the means for transmitting may be further configured to transmit a second message indicating a linkage of the ML models to respective ML model identifiers.

The aforementioned means may be one or more of the aforementioned components of the apparatus 1302 configured to perform the functions recited by the aforementioned means. As described supra, the apparatus 1302 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Accordingly, aspects of the present disclosure allow a UE to provide detailed reporting to a base station regarding the UE's measurement behaviors or calculation schemes that the UE applied to determine its signal quality measurements (e.g., L1-RSRPs or L1-SINRs). This detailed information may include, for example, whether the reported L1-RSRPs/L1-SINRs are associated with an instantaneous measurement, the specific time instances associated with the instantaneous measurement, the reception beams associated with the measurement, whether filtering is applied on the reported L1-RSRPs/L1-SINRs, the specific filtering schemes associated with the L1-RSRPs/L1v-SINRs, a time window or time instances associated with the filtering schemes, reception beams associated with the different time instances associated with the filtering schemes, and through what signaling the L1-RSRP or L1-SINR calculation schemes are reported, for instance, via RRC, MAC-CE, UCI, or application layer protocols. As a result, the base station may have a more reliable collection of data to apply to an AI/ML model for base station-based beam prediction, improving beam management performance or other AI/ML-based beam management.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is an apparatus for wireless communication, including: a processor; memory coupled with the processor; and instructions stored in the memory and operable, when executed by the processor, to cause the apparatus to: transmit a message indicating a measurement behavior of the apparatus; receive a reference signal associated with a channel measurement resource (CMR); and transmit a report indicating a layer 1 (L1) signal quality metric associated with the CMR, the L1signal quality metric being based on the measurement behavior.

Example 2 is the apparatus of Example 1, wherein the measurement behavior is at least one of: a first behavior in which the apparatus performs instantaneous measurements of CMRs at respective time instances to obtain L1 signal quality metrics; a second behavior in which the apparatus performs filtering on measurements of the CMRs to obtain the L1 signal quality metrics, the filtering being one or more of temporal filtering, spatial filtering, analytical filtering, or machine learning (ML) based filtering; or a third behavior in which the apparatus performs the instantaneous measurements or the filtering based on one or more parameters, the one or more parameters including a total quantity of the CMRs, a periodicity of the CMRs, a total quantity of the L1 signal quality metrics, a periodic CMR type, a semi-persistent CMR type, an aperiodic CMR type, a reference signal receive power (RSRP) report quantity, or a signal to noise and interference ratio (SINR) report quantity.

Example 3 is the apparatus of Examples 1 or 2, wherein the measurement behavior indicates that the L1 signal quality metric is associated with an instantaneous measurement of the CMR at a time instance.

Example 4 is the apparatus of Example 3, wherein the report further indicates the time instance.

Example 5 is the apparatus of Examples 3 or 4, wherein the report further indicates a reception beam associated with the instantaneous measurement.

Example 6 is the apparatus of any of Examples 1 to 5, wherein the measurement behavior indicates that the LI signal quality metric is a filtered measurement.

Example 7 is the apparatus of Example 6, wherein the report further indicates filtering information associated with the filtered measurement.

Example 8 is the apparatus of Example 7, wherein the filtering information indicates a time window associated with the filtered measurement.

Example 9 is the apparatus of Examples 7 or 8, wherein the filtering information indicates a plurality of time instances associated with the filtered measurement.

Example 10 is the apparatus of Example 9, wherein the filtering information indicates a reception beam associated with a respective one of the time instances.

Example 11 is the apparatus of any of Examples 7 to 10, wherein the filtering information includes information associated with a different CMR than the CMR associated with the filtered measurement.

Example 12 is the apparatus of any of Examples 7 to 11, wherein the filtering information includes an analytical filtering parameter.

Example 13 is the apparatus of any of Examples 7 to 12, wherein the filtering information indicates a machine learning (ML) model of the apparatus, the filtered measurement being an output of the ML model.

Example 14 is the apparatus of any of Examples 1 to 13, wherein the message indicating the measurement behavior is a radio resource control (RRC) message.

Example 15 is the apparatus of Example 14, wherein the RRC message includes a plurality of measurement behaviors including the measurement behavior.

Example 16 is the apparatus of Examples 14 or 15, wherein the instructions, when executed by the processor, further cause the apparatus to: receive a second message indicating the apparatus to apply the measurement behavior; wherein the second message is another RRC message, a medium access control (MAC) control element (MAC-CE), or downlink control information (DCI).

Example 17 is the apparatus of any of Examples 1 to 13, wherein the message indicating the measurement behavior is a medium access control (MAC) control element (MAC-CE).

Example 18 is the apparatus of Example 17, wherein the instructions, when executed by the processor, further cause the apparatus to: receive an acknowledgment of the MAC-CE, wherein the L1 signal quality metric being based on the measurement behavior is based on the acknowledgment.

Example 19 is the apparatus of Examples 17 or 18, wherein the instructions, when executed by the processor, further cause the apparatus to: transmit a second message indicating a different measurement behavior of the apparatus, the second message being a radio resource control (RRC) message or another MAC-CE; wherein the measurement behavior indicated in the MAC-CE overrides the different measurement behavior indicated in the second message.

Example 20 is the apparatus of any of Examples 17 to 19, wherein the instructions, when executed by the processor, further cause the apparatus to: transmit a radio resource control (RRC) message indicating a plurality of measurement behaviors including the measurement behavior, wherein the MAC-CE selects the measurement behavior from the plurality of measurement behaviors.

Example 21 is the apparatus of any of Examples 1 to 13, wherein the message indicating the measurement behavior is uplink control information (UCI), and the UCI further includes the report indicating the L1 signal quality metric associated with the measurement behavior.

Example 22 is the apparatus of Example 21, wherein the instructions, when executed by the processor, further cause the apparatus to: transmit a second message indicating a second measurement behavior of the apparatus, the second message being a radio resource control (RRC) message or another MAC-CE; wherein the UCI indicates the measurement behavior in response to the measurement behavior being different than the second measurement behavior.

Example 23 is the apparatus of Examples 21 or 22, wherein the instructions, when executed by the processor, further cause the apparatus to: transmit a second message indicating a plurality of measurement behaviors of the apparatus, the second message being a radio resource control (RRC) message or another MAC-CE, wherein the UCI selects the measurement behavior from the plurality of measurement behaviors.

Example 24 is the apparatus of any of Examples 1 to 13, wherein the message indicating the measurement behavior is transmitted in an application layer of the apparatus.

Example 25 is the apparatus of Example 24, wherein the measurement behavior indicates that the L1 signal quality metric is a filtered measurement output from a machine learning (ML) model of the apparatus.

Example 26 is the apparatus of Example 25, wherein the message further indicates a plurality of machine learning (ML) models of the apparatus, and the instructions, when executed by the processor, further cause the apparatus to: transmit a second message indicating a linkage of the ML models to respective ML model identifiers; wherein the report includes the respective ML model identifier of the ML model associated with the measurement behavior; and wherein the report is transmitted in a radio resource control (RRC) message, a medium access control (MAC) control element (MAC-CE), or uplink control information (UCI).

Example 27 is the apparatus of any of Examples 1 to 26, wherein the report is associated with a channel state information (CSI) report configuration indicating a time restriction for channel measurements, and wherein the L1 signal quality metric being based on the measurement behavior is based on the time restriction being not configured.

Example 28 is a method of wireless communication at a user equipment (UE), including: transmitting a message indicating a measurement behavior of the UE; receiving a reference signal associated with a channel measurement resource (CMR); and transmitting a report indicating a layer 1 (L1) signal quality metric associated with the CMR, the L1 signal quality metric being based on the measurement behavior.

Example 29 is an apparatus for wireless communication, including: means for transmitting a message indicating a measurement behavior of the apparatus; and means for receiving a reference signal associated with a channel measurement resource (CMR); wherein the means for transmitting is further configured to transmit a report indicating a layer 1 (L1) signal quality metric associated with the CMR, the L1 signal quality metric being based on the measurement behavior.

Example 30 is a non-transitory, computer-readable medium storing computer executable code, the code when executed by a processor cause the processor to: transmit a message indicating a measurement behavior of a user equipment (UE); receive a reference signal associated with a channel measurement resource (CMR); and transmit a report indicating a layer 1 (L1) signal quality metric associated with the CMR, the L1 signal quality metric being based on the measurement behavior.

What is claimed is:

1. An apparatus for wireless communication, comprising:
a processor;
memory coupled with the processor; and
instructions stored in the memory and operable, when executed by the processor, to cause the apparatus to:
transmit a message indicating a measurement behavior of the apparatus;
receive a reference signal associated with a channel measurement resource (CMR); and
transmit a report indicating a layer 1 (L1) signal quality metric associated with the CMR, the L1 signal quality metric being based on the measurement behavior.

2. The apparatus of claim 1, wherein the measurement behavior is at least one of:
a first behavior in which the apparatus performs instantaneous measurements of CMRs at respective time instances to obtain L1 signal quality metrics;
a second behavior in which the apparatus performs filtering on measurements of the CMRs to obtain the L1 signal quality metrics, the filtering being one or more of temporal filtering, spatial filtering, analytical filtering, or machine learning (ML) based filtering; or
a third behavior in which the apparatus performs the instantaneous measurements or the filtering based on one or more parameters, the one or more parameters including a total quantity of the CMRs, a periodicity of the CMRs, a total quantity of the L1 signal quality metrics, a periodic CMR type, a semi-persistent CMR type, an aperiodic CMR type, a reference signal receive power (RSRP) report quantity, or a signal to noise and interference ratio (SINR) report quantity.

3. The apparatus of claim 1, wherein the measurement behavior indicates that the L1 signal quality metric is associated with an instantaneous measurement of the CMR at a time instance.

4. The apparatus of claim 3, wherein the report further indicates the time instance.

5. The apparatus of claim 3, wherein the report further indicates a reception beam associated with the instantaneous measurement.

6. The apparatus of claim 1, wherein the measurement behavior indicates that the L1 signal quality metric is a filtered measurement.

7. The apparatus of claim 6, wherein the report further indicates filtering information associated with the filtered measurement.

8. The apparatus of claim 7, wherein the filtering information indicates a time window associated with the filtered measurement.

9. The apparatus of claim 7, wherein the filtering information indicates a plurality of time instances associated with the filtered measurement.

10. The apparatus of claim 9, wherein the filtering information indicates a reception beam associated with a respective one of the time instances.

11. The apparatus of claim 7, wherein the filtering information includes information associated with a different CMR than the CMR associated with the filtered measurement.

12. The apparatus of claim 7, wherein the filtering information includes an analytical filtering parameter.

13. The apparatus of claim 7, wherein the filtering information indicates a machine learning (ML) model of the apparatus, the filtered measurement being an output of the ML model.

14. The apparatus of claim 1, wherein the message indicating the measurement behavior is a radio resource control (RRC) message.

15. The apparatus of claim 14, wherein the RRC message includes a plurality of measurement behaviors including the measurement behavior.

16. The apparatus of claim 14, wherein the instructions, when executed by the processor, further cause the apparatus to:
receive a second message indicating the apparatus to apply the measurement behavior;
wherein the second message is another RRC message, a medium access control (MAC) control element (MAC-CE), or downlink control information (DCI).

17. The apparatus of claim 1, wherein the message indicating the measurement behavior is a medium access control (MAC) control element (MAC-CE).

18. The apparatus of claim 17, wherein the instructions, when executed by the processor, further cause the apparatus to:
receive an acknowledgment of the MAC-CE, wherein the L1 signal quality metric being based on the measurement behavior is based on the acknowledgment.

19. The apparatus of claim 17, wherein the instructions, when executed by the processor, further cause the apparatus to:
transmit a second message indicating a different measurement behavior of the apparatus, the second message being a radio resource control (RRC) message or another MAC-CE;
wherein the measurement behavior indicated in the MAC-CE overrides the different measurement behavior indicated in the second message.

20. The apparatus of claim 17, wherein the instructions, when executed by the processor, further cause the apparatus to:
transmit a radio resource control (RRC) message indicating a plurality of measurement behaviors including the measurement behavior, wherein the MAC-CE selects the measurement behavior from the plurality of measurement behaviors.

21. The apparatus of claim 1, wherein the message indicating the measurement behavior is uplink control information (UCI), and the UCI further includes the report indicating the L1 signal quality metric associated with the measurement behavior.

22. The apparatus of claim 21, wherein the instructions, when executed by the processor, further cause the apparatus to:
transmit a second message indicating a second measurement behavior of the apparatus, the second message being a radio resource control (RRC) message or another MAC-CE;
wherein the UCI indicates the measurement behavior in response to the measurement behavior being different than the second measurement behavior.

23. The apparatus of claim 21, wherein the instructions, when executed by the processor, further cause the apparatus to:
transmit a second message indicating a plurality of measurement behaviors of the apparatus, the second message being a radio resource control (RRC) message or another MAC-CE, wherein the UCI selects the measurement behavior from the plurality of measurement behaviors.

24. The apparatus of claim 1, wherein the message indicating the measurement behavior is transmitted in an application layer of the apparatus.

25. The apparatus of claim 24, wherein the measurement behavior indicates that the L1 signal quality metric is a filtered measurement output from a machine learning (ML) model of the apparatus.

26. The apparatus of claim 25, wherein the message further indicates a plurality of machine learning (ML) models of the apparatus, and the instructions, when executed by the processor, further cause the apparatus to:
transmit a second message indicating a linkage of the ML models to respective ML model identifiers;
wherein the report includes the respective ML model identifier of the ML model associated with the measurement behavior; and
wherein the report is transmitted in a radio resource control (RRC) message, a medium access control (MAC) control element (MAC-CE), or uplink control information (UCI).

27. The apparatus of claim 1, wherein the report is associated with a channel state information (CSI) report configuration indicating a time restriction for channel measurements, and wherein the L1 signal quality metric being based on the measurement behavior is based on the time restriction being not configured.

28. A method of wireless communication at a user equipment (UE), comprising:
transmitting a message indicating a measurement behavior of the UE;
receiving a reference signal associated with a channel measurement resource (CMR); and
transmitting a report indicating a layer 1 (L1) signal quality metric associated with the CMR, the L1 signal quality metric being based on the measurement behavior.

29. An apparatus for wireless communication, comprising:
means for transmitting a message indicating a measurement behavior of the apparatus; and
means for receiving a reference signal associated with a channel measurement resource (CMR);
wherein the means for transmitting is further configured to transmit a report indicating a layer 1 (L1) signal quality metric associated with the CMR, the L1 signal quality metric being based on the measurement behavior.

30. A non-transitory, computer-readable medium storing computer executable code, the code when executed by a processor cause the processor to:
transmit a message indicating a measurement behavior of a user equipment (UE);
receive a reference signal associated with a channel measurement resource (CMR); and
transmit a report indicating a layer 1 (L1) signal quality metric associated with the CMR, the L1 signal quality metric being based on the measurement behavior.
